(19) United States
(12) Patent Application Publication
(10) Pub. No.: US 2010/0223114 A1
(43) Pub. Date: Sep. 2, 2010

(54) DIGITAL SIGNAGE PROOF OF PLAY

(75) Inventors: Lei Yao, Great Falls, VA (US); Lee Sudduth, Pittsboro, NC (US)

Correspondence Address: EDELL, SHAPIRO & FINNAN, LLC, 1901 RESEARCH BOULEVARD, SUITE 400, ROCKVILLE, MD, 20850, US

(73) Assignee: Cisco Technology, San Jose, CA (US)

(21) Appl. No.: 12/396,124

(22) Filed: Mar. 2, 2009

(51) Int. Cl. G06Q 10/00; G06Q 30/00

(52) U.S. Cl. 705/14.12; 705/30

(57) ABSTRACT

Embodiments of the present invention include a method and apparatus comprising obtaining first information indicative of content for rendering on a display as digital signage; obtaining second information indicative of the content as played by a player for rendering on the display; and ascertaining a proof-of-play of the content when the first and second information are in correspondence.

### BACKGROUND

1. Field

The following generally relates to digital signage, and more particularly, to a method and apparatus for providing proof-of-play of digital signage.

2. Related Art

Digital signage systems have become widely accepted and deployed in many markets, including, for example, retail, sporting and entertainment industries. Given the large deployment of such digital signage systems, especially those located in public places, like shopping malls, sporting arenas, etc, businesses are now exploiting such digital signage systems to advertize for themselves and/or other third parties to increase and/or obtain new sources of revenue (collectively “revenue sources”).

The revenue sources generally depend on a given advertisement model. This advertisement model requires, for billing and/or auditing of any given advertisement, some type of verification and/or confirmation that such advertisement is played on certain digital displays for certain durations. The verification and/or confirmation are commonly referred to as proof-of-play. By obtaining the proof-of-play, the businesses can perform reporting of the proof-of-play (“proof-of-play reporting”) to track usage and generate invoices. In addition, the proof-of-play reporting can be used for trouble shooting and other system operations purpose. Presently, proof of play is assumed when a particular display is scheduled or a manual (video recording or viewer-based) system is used to capture the proof.

Therefore, there is a need in the art for an automated technique for capturing and reporting proof-of-play information.

### BRIEF DESCRIPTION OF THE DRAWINGS

So the manner in which the above recited features are attained and can be understood in detail, a more detailed description is described below with reference to Figures illustrated in the appended drawings.

The Figures in the appended drawings, like the detailed description, are examples. As such, the Figures and the detailed description are not to be considered limiting, and other equally effective examples are possible and likely. Furthermore, like reference numerals in the Figures indicate like elements, and wherein:

FIG. 1 is a block diagram illustrating example architecture of a system for providing proof-of-play of digital signage;

FIG. 2 is a flow diagram illustrating an example flow for providing proof-of-play of digital signage;

FIG. 3 is a flow diagram illustrating an example flow for providing proof-of-play of digital signage;

FIG. 4 is a flow diagram illustrating an example flow for providing proof-of-play of digital signage;

FIG. 5 is a flow diagram illustrating an example flow for providing a proof-of-play of digital signage;

FIG. 6 is a block diagram illustrating another example architecture of a system for providing proof-of-play of digital signage;

FIG. 7 is a block diagram illustrating an example architecture of a player for providing proof-of-play of digital signage;

FIG. 8 is a flow diagram illustrating an example flow for providing proof-of-play of digital signage;

FIG. 9 is a block diagram illustrating another example architecture of a system for providing proof-of-play of digital signage; and

FIG. 10 is a flow diagram illustrating an example flow for providing proof-of-play of digital signage.

### DESCRIPTION OF EXAMPLE EMBODIMENTS

### Overview

Embodiments of the present invention include a method and apparatus comprising obtaining first information indicative of content for rendering on a display as digital signage; obtaining second information indicative of the content as played by a player for rendering on the display; and ascertaining a proof-of-play of the content when the first and second information are in correspondence.

### Example Architecture

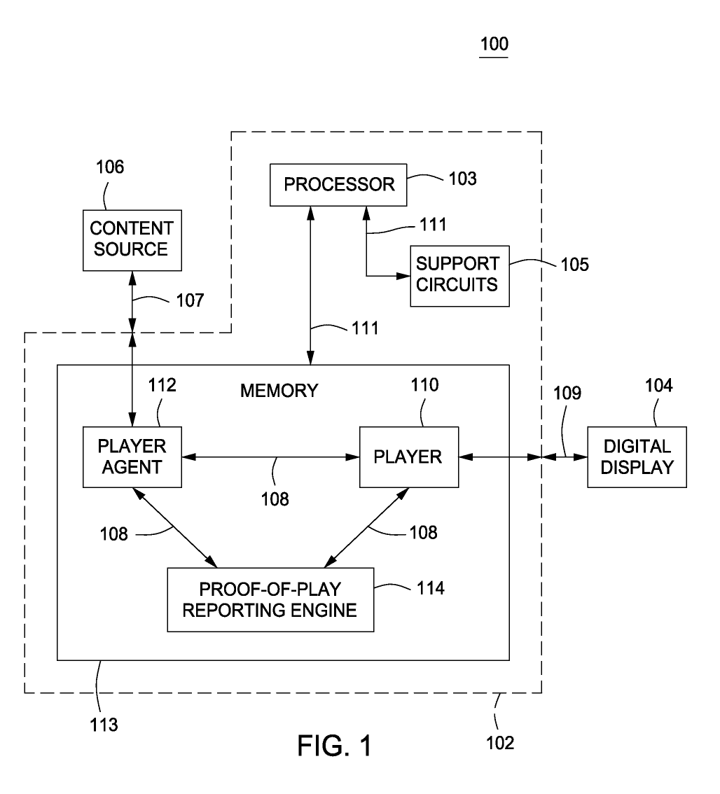

FIG. 1 is a block diagram illustrating example architecture of a system 100 for providing proof-of-play of digital signage. The system 100 includes a computing platform 102, a digital display 104 and a content source 106.

The content source 106 includes a number of elements, none of which are shown for simplicity of exposition. In general, the content source 106 includes a processor-based platform (a computer) that operates on any suitable operating system and other software for performing functions described herein. The content source 106, for example, is operable to host content (“source content”) for use as digital signage. In addition, the content source 106 is operable to source or exchange with the computing platform 102, via a communication link 107, one or more copies of the source content (“source-content copies”) for rendering on the digital display 104.

One example of the content source 106 is a web server or a combination of one or more web servers configured to host and to source the source-content copies to the computer platform 102. In such case, the source content may be maintained at the content source 106 in one or more web pages; each of which may be formed in accordance with a HyperText Markup Language (“HTML”) or other like-type protocol, and/or accessible via a logical-link indicator, such as a uniform resource identifier and/or a uniform resource locator.

The source content may include any type of information that the computing platform 102 can process for rendering or otherwise causing presentation at the digital display 104. Typically, the source content includes any of visual, tactile and auditive information.

The content source 106 may source the source content using any number of forms of delivery. For example, the content source 106 may download and/or stream any of audio, video, text and multimedia information to the computing platform 102, responsive to the computing platform 102 sending a request for the source content (“source-content request”). The source-content request may include, for example, the logical-link indicator so as to facilitate locating the source content, and in turn, and delivering the source-content copies to the computer platform 102.

Alternatively and/or additionally, the content source 106 may source the source content without receiving the source-content request. For example, the content source 106 may push, upon an occurrence of an event, the source-content copies to the computing platform 102. As another alternative, the content source 106 and the computing platform may use a synchronization routine to exchange the source-content copies.

The digital display 104 generally includes a number of elements, many of which are not shown for simplicity of exposition. In general, the digital display 104 includes logic to render, as digital signage, the source-content copies that are processed or played (“rendering content”) by the computing platform 102, and received via a link 109. As used herein and described in more detail below, “played” should be understood as output from the computing platform 102 (or portion thereof) for rendering on the digital display 104.

The digital display 104 may include a flat panel monitor, such as a Liquid Crystal Display (“LCD”), plasma and like-type monitors, onto which to render visual components of the rendering content. The digital display 104 may also include audio reproduction devices, such as a speaker and/or speaker system, through which to render audio components of the rendering content. In addition, the digital display 104 may include tactile output devices, such as vibratory pads and/or Braille-code generators, through which to render tactile components of the rendering content.

The computing platform 102 generally includes a number of elements, many of which are not shown for simplicity of exposition. Typically, the computing platform 102 includes a processor-based platform that operates on any suitable operating system and other software for performing functions described herein.

The computing platform 102 may be formed as or in a single unitary device and concentrated on such device. Alternatively, the computing platform 102 may be formed in or from one or more separate devices, and as such, may be distributed among a number of devices. The computing platform 102 may be scalable; i.e., the computing platform 102 may employ any of a scale-up and scale-out approach. In addition, the computing platform 102 may be integrated into or otherwise combined with another apparatus.

The computing platform 102 includes one or more processing units (collectively “processor”) 103, memory 113, support circuits 105. Any of the processor, memory, and support circuits may communicatively couple via one or more communication links or bus 111.

The support circuits 105 may comprise any of the well-known circuits that support the functionality of the processor 103, including I/O interfaces, buses, clock circuits, power supplies and the like.

The memory 113 may store various software packages, including the operating system and a number of functional modules, including a player 110, a player agent 112 and a proof-of-play reporting engine 114. The operating system may include may include one or more programmable and/or hard-coded functions, instructions, commands, directions, code and/or control data (collectively, “directives”) for operating the computing platform 102. When retrieved from the memory and executed by the processor, the computing platform 102 becomes a platform onto which the functional modules can be executed i.e., a general purpose computer becomes a specific purpose computer upon execution of the application software.

Each of functional modules, including player 110, player agent 112 and proof-of-play reporting engine 114, includes one or more directives for causing the processor and/or the computing platform 102 to perform functions defined by such functional modules to facilitate, at least in part, providing a proof-of-play of the digital signage. Any of the functional modules, including player 110, player agent 112 and proof-of-play reporting engine 114, may be in any of a standalone, client/server, peer-to-peer and other format. Alternatively and/or additionally, any of the functional modules may be formed as any of an autonomous agent, intelligent agent, autonomous intelligent agent, rational agent, intelligent software agent, distributed agent, mobile agent, fuzzy agent and the like.

Although each of functional modules, including the player 110, the player agent 112 and the proof-of-play reporting engine 114, are described herein as software packages, the functional modules and/or the directives thereof may be formed in hardware and/or firmware. For example, the functional modules and/or the directives thereof may be ported or otherwise arranged for and implemented in any of a field-programmable-gate array (“FPGA”), application-specific-integrated circuit (“ASIC”), system-on-a chip (“SoC”) and complex-programmable-logic device (“CPLD”).

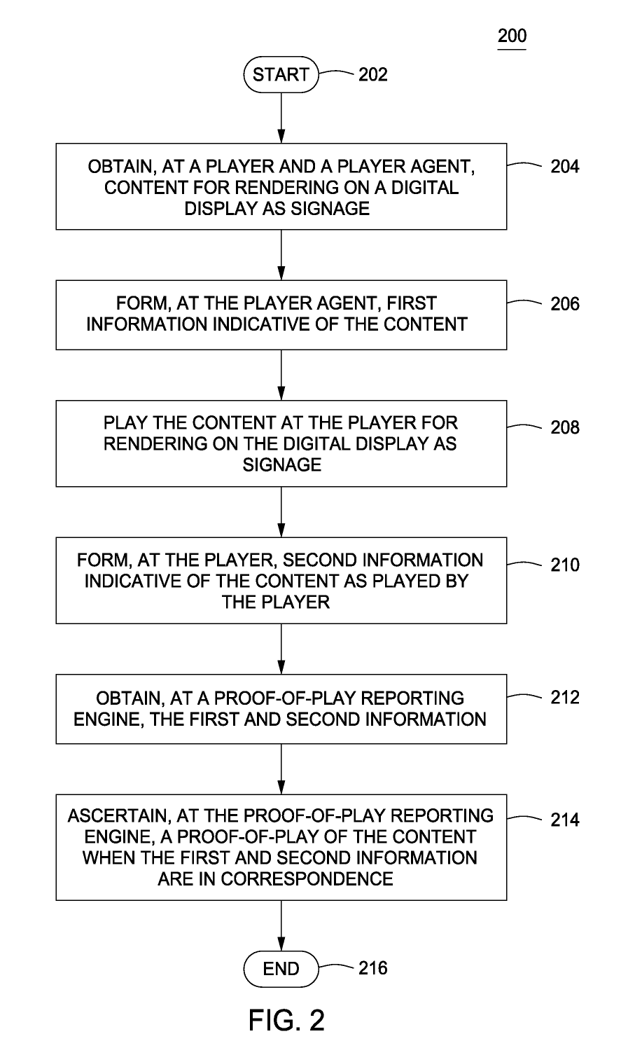

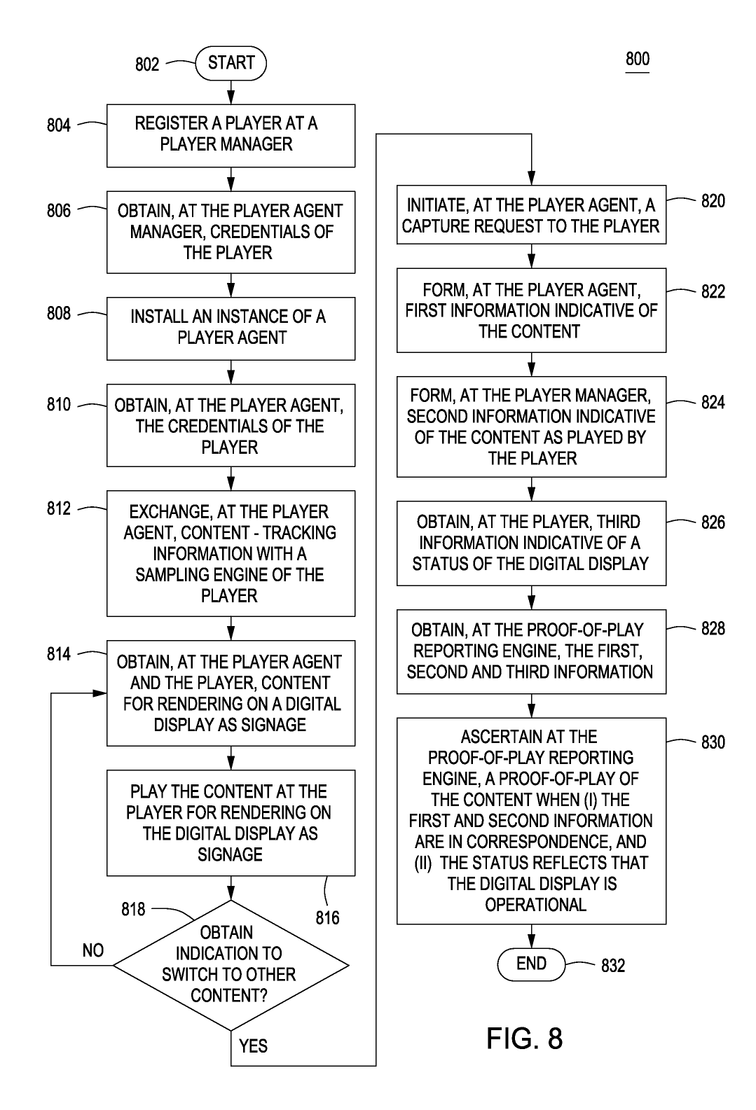

At least a portion of the functions of the functional modules, including player 110, player agent 112 and proof-of-play reporting engine 114, are described with respect to FIGS. 2-5. The functional interaction between the modules is represented by arrows 108. Additional portions of the functions of the functional modules, including player 110, player agent 112 and proof-of-play reporting engine 114, are described with respect to FIGS. 8-12.

### Example Operation

Referring now to FIG. 2, a flow diagram illustrating example flow 200 for providing proof-of-play of digital signage is shown. For convenience, the following describes the flow 200 with reference to the system architecture 100 of FIG. 1. The flow 200 may be carried out by other architectures as well.

The flow 200 starts at termination block 202. Prior to termination block 202, the computing platform 102 becomes operative, such that its various software packages are retrieved from the memory and executed by the processors, thereby, making the computing platform 102 function as one or more specially programmed computers for carrying out any of the functions noted above and below. Any reference below to the various software packages, including the functional modules, such as the player 110, player agent 112 and proof-of-play reporting engine 114, assumes that such software packages (and directives therein) are under execution, and thus, cause the processors, in conjunction with other portions of the computing platform 102, to carry out their functions noted above and below.

Sometime after termination block 202, the flow 200 may transition to process block 204. At the process block 204, the player 110 and the player agent 112 obtain the source-content copies from the content source 106. To facilitate this, each of the player 110 and the player agent 112 may exchange, transfer, deliver or otherwise provide (collectively “provide”), via links 107 and/or 108, respective source-content requests to the content source 106 to trigger the delivery of the source-content copies. As noted above, each of the respective source-content requests may include the logical-link indicator. In response to receiving the logical-link indicator, the content source 106 locates the source content, and in turn, provides the source-content copies to the player 110 and the player agent 112 via the I/O interfaces of the computer platform 102.

Alternatively, each of the player 110 and the player agent 112 may obtain the source-content copies without providing the respective source-content requests. For example, each of the player 110 and the player agent 112 may receive the source-content copies responsive to the content source 106 pushing the source-content copies thereto. The content source 106 may push the source-content copies to the player 110 and the player agent 112 after the occurrence of an event, such as in response to any of a scheduling of a time of play of the rendering content; an alert (e.g., any of a FEMA alert, Ambler alert, Red Cross request, Homeland Security alert, and NOAA warning); a change, revision, update, etc. to the source content; etc. As another alternative, each of the player 110 and the player agent 112 may obtain the source-content copies as a result of carrying out the synchronization routine with the content source 106.

After the process block 204, the flow 200 may transition to process block 206. At the process block 206, the player agent 112 forms a first set of information that is indicative, representative, symbolic, emblematic, etc. (collectively “indicative”) of the source-content copies. The player agent 112 may form this first set of information (“proofing information”) by processing the source-content copies into a form that is indicative of the source-content copies. This form may be, for example, any of a snapshot, checksum and bit-mapped image of the source-content copies. After the process block 206, the flow 200 may transition to process block 208.

At the process block 208, the player 110 plays the rendering content for rendering on the digital display 104. To facilitate this, the player 110 may process the source-content copies into the rendering content, and as noted above, output the rendering content to the digital display 104. After the process block 208, the flow 200 may transition to process block 210.

At the process block 210, the player 110 forms a second set of information that is indicative of the rendering content. The player 110 may form the second set of information (“confirming information”) by processing the rendering content into a form that is indicative of the source-content copies. This form may be, for example, any of a snapshot, checksum and bit-mapped image of the source-content copies. In addition, the forms of the confirming information and the proofing information may be the same and/or similar to each other. Alternatively, the form of the confirming information may be derivable from the form of the proofing information (or vice versa). Additionally and/or alternatively, the forms of the proofing and confirming information may be derivable from a reference or standard. After the process block 210, the flow 200 may transition to process block 212.

At the process block 212, the proof-of-play reporting engine 114 obtains the first and second sets of (i.e., proofing and confirming) information. The proof-of-play reporting engine 114 may obtain the proofing and confirming information from the player 110 and the player agent 112 via transfers over respective links 108. To facilitate obtaining the proofing and confirming information, the proof-of-play reporting engine 114 may provide to the player 110 and the player agent 112, via links 108, respective requests for the proofing and confirming information so as to trigger the delivery of such information. In response to these requests, the player 110 and the player agent 112 locate the proofing and confirming information, respectively, and in turn, provide the proofing and confirming information to proof-of-play reporting engine 114, via links 108.

Alternatively, the proof-of-play reporting engine 114 may obtain the proofing and confirming information without providing the requests to the player 110 and the player agent 112. Instead, the player 110 and the player agent 112 may push the proofing and confirming information to the proof-of-play reporting engine 114. The pushing of the proofing and confirming information may occur after the occurrence of an event, such as in response to any of a schedule; a play of the rendering content; and a change, revision, update, etc. to the source content; etc. As another alternative, the proof-of-play reporting engine 114 may obtain the proofing and confirming information as a result of carrying out respective synchronization routines with player 110 and the player agent 112.

After the process block 212, the flow 200 may transition to process block 214. At the process block 214, the proof-of-play reporting engine 114 ascertains a proof-of-play of the source content when the proofing and confirming information are in correspondence or otherwise correlate. This may include, for example, the proof-of-play reporting engine 114 ascertaining the proof-of-play as a function of a comparison between the proofing and confirming information. To do this, the proof-of-play reporting engine 114 may first generate a result from the comparison, and then make a determination as to whether the result satisfies a given threshold. And when the determination indicates that the result satisfies the given threshold, the proofing and confirming information are in correspondence or otherwise correlate.

Assume, for example, the forms of the proofing and confirming information are the same, and that they are respective checksums of the source-content copies and the rendering content. To ascertain the proof-of-play, the proof-of-play reporting engine 114 may compare the proofing-information checksum with confirming-information checksum to obtain a difference (mathematical, statistical or otherwise). Thereafter, the proof-of-play reporting engine 114 may compare this difference to the given threshold. And when the difference satisfies the given threshold, the proof-of-play reporting engine 114 determines that the proofing and confirming information are in correspondence, and in turn, ascertains the proof-of-play.

Although the foregoing example assumes the forms of the proofing and confirming information are the same and are respective checksums, the proof-of-play reporting engine 114 may ascertain the proof-of-play in a similar manner when the forms of the proofing and confirming information are similar to each other or derivable from one another or the reference or standard, and/or when they are snapshots, bit-maps, etc. In addition, the proof-of-play reporting engine 114 may ascertain the proof-of-play in other ways as well.

After the process block 214, the flow 200 may transition to termination block 216. At the termination block 216, the flow 200 terminates. Alternatively, the flow 200 may be repeated periodically, in continuous fashion, or upon being triggered as a result of a condition, such as an impetus to switch to different content (i.e., the fulfillment of the condition defines an event resulting in a trigger).

In addition, the process blocks 206-214 may be repeated periodically, in continuous fashion, or upon being triggered as a result of a condition, without repeating the entire flow 200. For example, the process blocks 206-214 may be repeated a number of times in response to impetuses to ascertain additional proofs-of play for the content. Other combinations and permutations are possible as well.

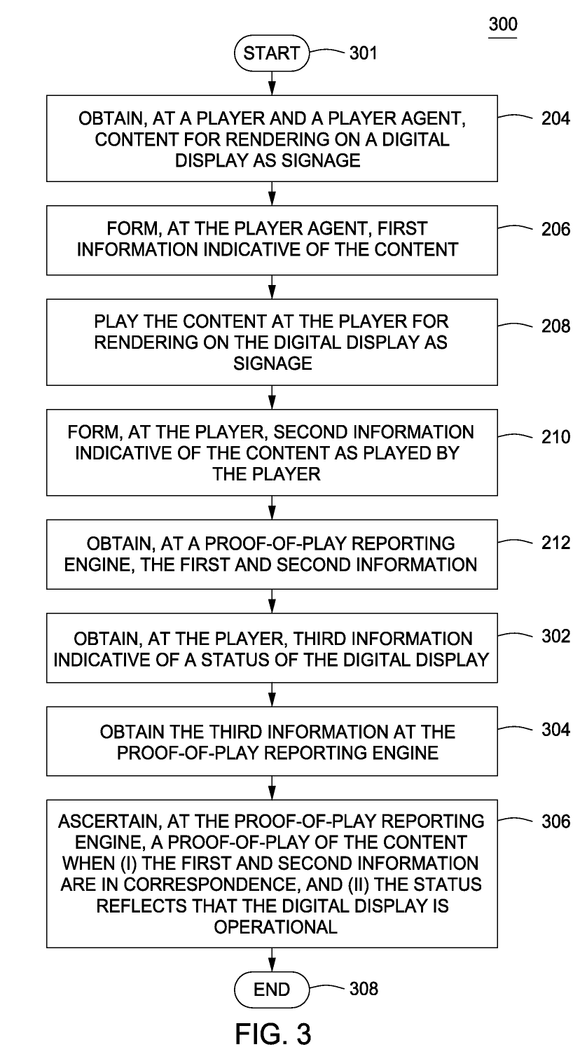

FIG. 3 is a flow diagram illustrating example flow 300 for providing proof-of-play of digital signage. For convenience, the following describes the flow 300 with reference to the architecture of system 100 of FIG. 1 and the flow 200 of FIG. 2. The flow 300 may be carried out by other architectures as well. In addition, the flow 300 is similar to the flow 200 of FIG. 2, except as described herein below.

After the process block 212, the flow 300 may transition to process block 302. At the process block 302, the player 110 obtains a third set of information that is indicative of a status of the digital display 104 (“display status”). To facilitate this, the player 110 may perform an examination or diagnostic of any of the display device 104 and/or the link 109. During (or as a result of performing) the examination or diagnostic, the player 110 may collect, ascertain or otherwise garner information relating to one or more states, conditions and/or health events of the display device 104 and/or the link 109. The player 110 may use this information (“health information”) to ascertain the display status. For example, the health information may indicate that the digital display 104 is unreachable for any given number of reasons, including, for example, the digital display 104 being in an off state, the link 109 being disconnected from the player 110 and/or the digital display 104 and/or one or more errors or problems with the digital display 104 and/or the link 109. Responsive to the health information indicating that the display 104 is unreachable, the player 100 may establish, set or otherwise cause (collectively “set”) the display status to indicate that the digital display 104 is non-operational.

Alternatively, the examination or diagnostic, and in turn, the health information may reveal no errors and/or problems with the digital display 104 and/or the link 109. Accordingly, the player 100 may set the display status to indicate that the digital display 104 is not non-operational. After the process block 302, the flow 300 may transition to process block 304.

At the process block 304, the proof-of-play reporting engine 114 obtains the proofing and confirming information along with the display status. The proof-of-play reporting engine 114 may obtain the proofing and display status from the player 110 and the confirmation information from the player agent 112 via transfers over respective links 108.

To facilitate obtaining the proofing information, display status and confirming information, the proof-of-play reporting engine 114 may provide to the player 110 and the player agent 112, via links 108, respective requests for the proofing information, confirming information and display status so as to trigger the delivery of such information. In response to these requests, the player 110 and the player agent 112 locate the proofing information and display status and the confirming information, respectively, and in turn, provide the proofing information, display status and the confirming information to proof-of-play reporting engine 114, via the links 108.

Alternatively, the proof-of-play reporting engine 114 may obtain the proofing information, display status and confirming information without providing the requests to the player 110 and the player agent 112. Instead, the player 110 and the player agent 112 may push the proofing information, display status and confirming information to the proof-of-play reporting engine 114. The pushing of the proofing information, display status and confirming information may occur after the occurrence of an event, such as in response to any of a schedule; a play of the rendering content; and a change, revision, update, etc. to the source content; etc. As another alternative, the proof-of-play reporting engine 114 may obtain the proofing information, display status and confirming information as a result of carrying out respective synchronization routines with player 110 and the player agent 112.

After the process block 304, the flow 300 may transition to process block 306, whereupon, the proof-of-play reporting engine 114 ascertains a proof-of-play of the source content when (i) the proofing and confirming information are in correspondence or otherwise correlate, and (ii) the display status reflects that the digital display 104 is operational. This may include, for example, the proof-of-play reporting engine 114 first ascertaining an intermediate proof-of-play as a function of a comparison between the proofing and confirming information. To do this, the proof-of-play reporting engine 114 may initially generate a result from the comparison, and then make a determination as to whether the result satisfies a given threshold. And when the determination indicates that the result satisfies the given threshold, the proofing and confirming information are in correspondence or otherwise correlate.

Assume, for example, the forms of the proofing and confirming information are the same, and that they are respective checksums of the source-content copies and the rendering content. To ascertain the intermediate proof-of-play, the proof-of-play reporting engine 114 may compare the proofing-information checksum with confirming-information checksum to obtain a difference (mathematical, statistical or otherwise). Thereafter, the proof-of-play reporting engine 114 may compare this difference to the given threshold. And when the difference satisfies the given threshold, the proof-of-play reporting engine 114 determines that the proofing and confirming information are in correspondence, and in turn, ascertains the intermediate proof-of-play.

Although the foregoing example assumes the forms of the proofing and confirming information are the same and are respective checksums, the proof-of-play reporting engine 114 may ascertain the intermediate proof-of-play in a similar manner when the forms of the proofing and confirming information are similar to each other or derivable from one another or the reference or standard, and/or when they are snapshots, bit-maps, etc. In addition, the proof-of-play reporting engine 114 may ascertain the intermediate proof-of-play in other ways as well.

After ascertaining the intermediate proof-of-play, the proof-of-play reporting engine 114 may examine the display status. If, upon examination, the display status indicates that the digital display 104 is non-operational, then the proof-of-play reporting engine 114 does not ascertain the proof-of-play. On the other hand, the proof-of-play reporting engine 114 ascertains the proof-of-play when the display status indicates that the digital display 104 is not non-operational.

While the foregoing describes the proof-of-play reporting engine 114 ascertaining the intermediate proof-of-play as a function of the proofing and confirming information, the proof-of-play reporting engine 114 may instead ascertain the intermediate proof-of-play as a function of the display status (i.e., when the display status reflects that the digital display 104 is not non-operational). Thereafter, the proof-of-play reporting engine 114 may ascertain the proof-of-play as a function of the proofing and confirming information.

After the process block 306, the flow 300 may transition to termination block 308. At the termination block 308, the flow 300 terminates. Alternatively, the flow 300 may be repeated periodically, in continuous fashion, or upon being triggered as a result of a condition, such as an impetus to switch to different content (i.e., the fulfillment of the condition defines an event resulting in a trigger).

In addition, the process blocks 206-306 may be repeated periodically, in continuous fashion, or upon being triggered as a result of a condition, without repeating the entire flow 200. For example, the process blocks 206-306 may be repeated a number of times in response to impetuses to ascertain additional proofs-of play for the content. Other combinations and permutations are possible as well.

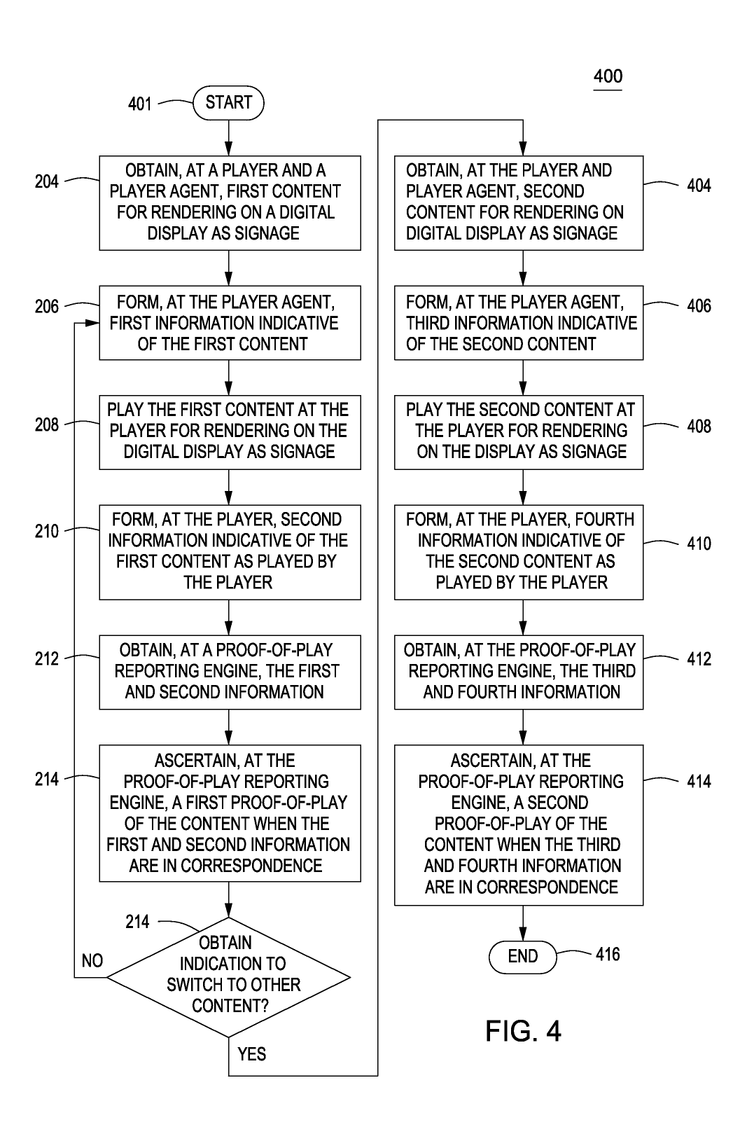

FIG. 4 is a flow diagram illustrating example flow 400 for providing proof-of-play of digital signage. For convenience, the following describes the flow 400 with reference to the architecture of system 100 of FIG. 1 and the flow 200 of FIG. 2. The flow 400 may be carried out by other architectures as well. In addition, the flow 400 is similar to the flow 200 of FIG. 2, except as described herein below.

The flow 400 begins at termination block 401. In accord with the description above with respect to FIGS. 2 and 3, the computing platform 102 becomes operative prior to termination block 401, such that its various software packages are retrieved from the memory and executed by the processors, thereby, making the computing platform 102 function as one or more specially programmed computers for carrying out any of the functions noted above and below. Any reference below to the various software packages, including the functional modules, such as the player 110, player agent 112 and proof-of-play reporting engine 114, assumes that such software packages (and directives therein) are under execution, and thus, cause the processors, in conjunction with other portions of the computing platform 102, to carry out their functions noted above and below.

After the termination block 401, the flow 400 may transition to process block 204. As indicated by the like-reference numerals, the functions of the process blocks 204-214 (and the functional modules carrying out such functions) are the same as those in FIG. 2, except that the source-content copies, logical-link indicator, proofing information, rendering content, confirming information and other like-type information are associated with a first set of source content (“first-source-content set”). For ease of exposition, the following refers to such source-content copies, logical-link indicator, proofing information, rendering content, confirming information and like-type information using “first” as a preamble.

After the process block 214, the flow 400 may transition to decision block 402. At the decision block 402, the player 110 and/or the player agent 112 makes a determination as to whether it has obtained an indication to switch to a second set of source content (“second-source-content set”). If neither the player 110 nor the player agent 112 makes the determination in the affirmative, the flow 400 may transition to process block 206 (shown) and/or wait for a given amount of time and return to decision block 402 (not shown). If, on the other hand, either the player 110 or the player agent 112 makes the determination in the affirmative, then flow 400 may transition to process block 404.

The player 110 and/or the player agent 112 may obtain the indication to switch to the second source-content set in any number of ways. For example, the player 110 and/or the player agent 112 may detect that the first source-content copies and/or the first-logical-link indicator have changed. To facilitate such detection, the player 110 and/or the player agent 112 may form checksums of the first source-content copies and/or the first logical-link indicator, and then monitor for changes in such checksums. Responsive to changes in any of the checksums, the player 110 or the player agent 112 makes the determination in the affirmative.

The player 110 and/or the player agent 112 may detect that the first source-content copies and/or the first logical-link indicator have changed as a result any change in and/or to the first source-content copies and/or the first logical-link indicator. This may include, for example, changes that result from obtaining source-content copies of the second source content set (“second source-content copies”) and/or obtaining a logical-link indicator for the second source content set (“second logical-link indicator”).

At process the block 404, the player 110 and the player agent 112 obtain the second source-content copies from the content source 106. To facilitate this, each of the player 110 and the player agent 112 may provide, via links 107 and/or 108, respective source-content requests to the content source 106 to trigger the delivery of the second source-content copies. Each of these respective source-content requests may include the second logical-link indicator. In response to receiving the second logical-link indicator, the content source 106 locates the second source-content set, and in turn, provides the second source-content copies to the player 110 and the player agent 112 via the I/O interfaces of the computer platform 102.

Alternatively, each of the player 110 and the player agent 112 may obtain the second source-content copies without providing the respective source-content requests. Each of the player 110 and the player agent 112 may, for example, receive the second source-content copies responsive to the content source 106 pushing the second source-content copies thereto. Each of the player 110 and the player agent 112 may, alternatively, obtain the second source-content copies as a result of carrying out the synchronization routine with the content source 106. After the process block 404, the flow 400 may transition to process block 406.

At the process block 406, the player agent 112 forms a third set of information that is indicative of the second source-content copies. The player agent 112 may form this third set of information (“second proofing information”) by processing the second source-content copies into a form that is indicative of the second source-content copies. This form may be, for example, any of a snapshot, checksum and bit-mapped image of the second source-content copies. After the process block 406, the flow 400 may transition to process block 408.

At the process block 408, the player 110 plays the second rendering content for rendering on the digital display 104. To facilitate this, the player 110 may process the second source-content copies into the second rendering content, and output the second rendering content to the digital display 104. After the process block 408, the flow 400 may transition to process block 410.

At the process block 410, the player 110 forms a fourth set of information that is indicative of the second rendering content. The player 110 may form the fourth set of information (“second confirming information”) by processing the second rendering content into a form that is indicative of the second source-content copies. This form may be, for example, any of a snapshot, checksum and bit-mapped image of the second source-content copies. In addition, the forms of the second confirming information and the second proofing information may be the same and/or similar to each other. Alternatively, the form of the second confirming information may be derivable from the form of the second proofing information (or vice versa). Additionally and/or alternatively, the forms of the second proofing and second confirming information may be derivable from a reference or standard. After the process block 410, the flow 400 may transition to process block 412.

At the process block 412, the proof-of-play reporting engine 114 obtains the third and fourth sets of (i.e., second proofing and second confirming) information. The proof-of-play reporting engine 114 may obtain the second proofing information and the second confirming information from the player 110 and the player agent 112 via transfers over respective links 108. To facilitate obtaining the second proofing information and second confirming information, the proof-of-play reporting engine 114 may provide to the player 110 and the player agent 112, via links 108, respective requests for the second proofing information and the second confirming information so as to trigger the delivery of such information. In response to these requests, the player 110 and the player agent 112 locate the second proofing information and the second confirming information, respectively, and in turn, provide such information to proof-of-play reporting engine 114, via links 108.

Alternatively, the proof-of-play reporting engine 114 may obtain the second proofing information and the second confirming information without providing the requests to the player 110 and the player agent 112. The player 110 and the player agent 112 may, instead, push the second proofing and second confirming information to the proof-of-play reporting engine 114. The pushing of the second proofing and second confirming information may occur after the occurrence of an event, such as in response to any of a schedule; a play of the rendering content; and a change, revision, update, etc. to the source content; etc. As another alternative, the proof-of-play reporting engine 114 may obtain the second proofing and second confirming information as a result of carrying out synchronization routines with player 110 and the player agent 112. After the process block 412, the flow 400 may transition to process block 414.

At the process block 414, the proof-of-play reporting engine 114 ascertains a second proof-of-play of the second source content when the second proofing and second confirming information are in correspondence or otherwise. This may include, for example, the proof-of-play reporting engine 114 ascertaining the second proof-of-play as a function of a second comparison between the second proofing information and the second confirming information. To do this, the proof-of-play reporting engine 114 may first generate a second result from the second comparison, and then make a second determination as to whether the second result satisfies a second given threshold. And when the second determination indicates that the second result satisfies the second given threshold, the second proofing and second confirming information are in correspondence or otherwise correlate.

Assume, for example, the forms of the second proofing and confirming information are the same, and that they are respective snapshots of the second source-content copies and the second rendering content. To ascertain the second proof-of-play, the proof-of-play reporting engine 114 may compare one or more portions of the second proofing-information snapshot with one or more corresponding portions of the second confirming-information snapshot to obtain a second difference (mathematical, statistical or otherwise). Thereafter, the proof-of-play reporting engine 114 compares this second difference to the second given threshold. And when the second difference satisfies the second given threshold, the proof-of-play reporting engine 114 determines that the second proofing and confirming information are in correspondence, and in turn, ascertains the second proof-of-play.

Although the foregoing example assumes the forms of the second proofing and second confirming information are the same and are respective snapshots, the proof-of-play reporting engine 114 may ascertain the second proof-of-play in a similar manner when the forms of the second proofing and second confirming information are similar to each other or derivable from one another or another reference or standard, and/or when they are snapshots, bit-maps, etc. In addition, the proof-of-play reporting engine 114 may ascertain the second proof-of-play in other ways as well.

After the process block 414, the flow 400 may transition to termination block 416. At the termination block 416, the flow 200 terminates. Alternatively, the flow 400 may be repeated periodically, in continuous fashion, or upon being triggered as a result of a condition, such as an impetus to switch to different content (i.e., the fulfillment of the condition defines an event resulting in a trigger).

In addition, the process blocks 206-414 may be repeated periodically, in continuous fashion, or upon being triggered as a result of a condition, without repeating the entire flow 400. For example, the process blocks 206-414 may be repeated a number of times in response to impetuses to ascertain additional proofs-of play for the content. Other combinations and permutations are possible as well.

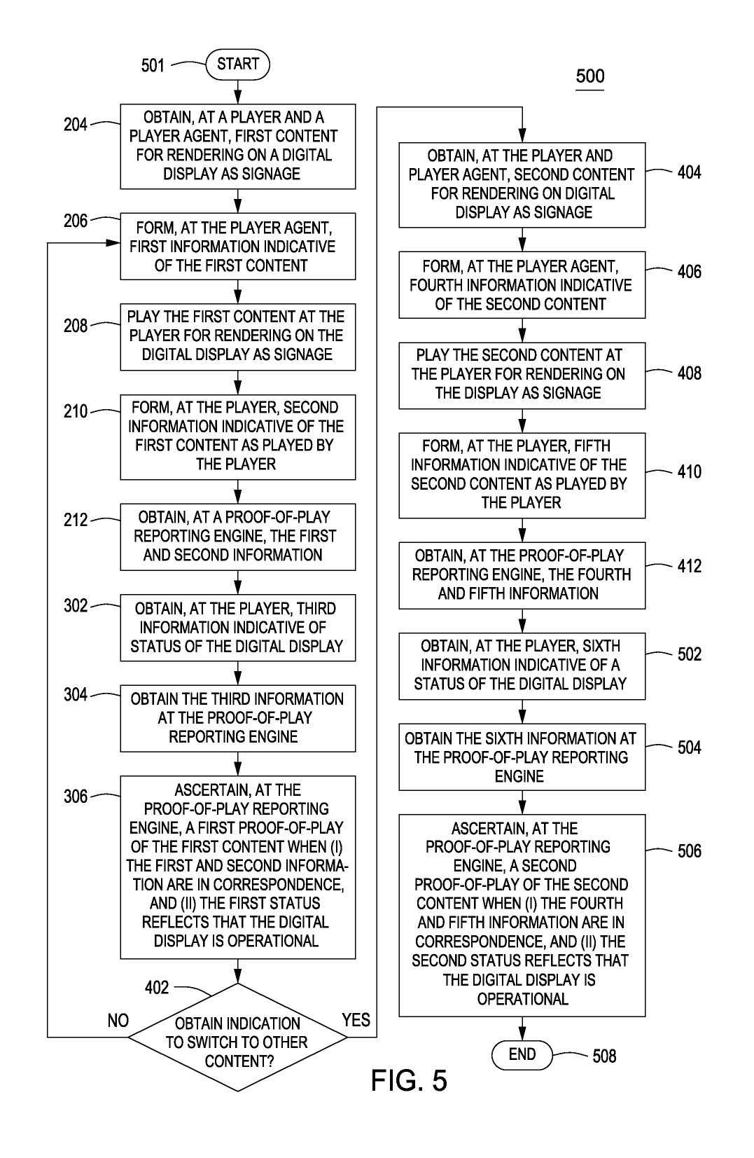

Referring now to FIG. 5, a flow diagram illustrating example flow 500 for providing a proof-of-play of digital signage is shown. For convenience, the following describes the flow 500 with reference to the architecture of system 100 of FIG. 1, the flow 200 of FIG. 2, the flow 300 of the FIG. 3, and the flow 400 of the FIG. 4. The flow 500 may be carried out by other architectures as well. In addition, the flow 500 is similar to the flow 400 of FIG. 4, except as described herein below.

As indicated by the like-reference numerals, the functions of the process blocks 204-306 (and the functional modules carrying out such functions) are the same as those in FIGS. 2 and 3, except that the source-content copies, logical-link indicator, proofing information, rendering content, confirming information, health information, display status and like-type information are associated with a first set of source content (“first-source-content set”). For ease of exposition, the following refers to such source-content copies, logical-link indicator, proofing information, rendering content, confirming information, health information, display status and like-type information using “first” as a preamble.

After the process block 412, the flow 500 may transition to process block 502. At the process block 502, the player 110 obtains a set of information (“second display-status information”) that is indicative of a second status of the digital display 104. To facilitate this, the player 110 may first perform another examination or diagnostic of any of the display device 104 and/or the link 109. During (or as a result of performing) such examination or diagnostic, the player 110 may collect, ascertain or otherwise garner information relating to one or more second states, conditions and/or health events of the display device 104 and/or the link 109. The player 110 may use this information (“second health information”) to ascertain the second display status.

For example, the second health information may indicate that either the digital display 104 is unreachable for any given number of reasons, including, for example, the digital display 104 being in an off state, the link 109 being disconnected from the player 110 and/or the digital display 104 and/or one or more errors or problems with the digital display 104 and/or the link 109. The player 110, response to the second health information indicating that the display 104 is unreachable, may set the second display status to indicate that the digital display 104 is non-operational.

Alternatively, the examination or diagnostic, and in turn, the second health information may reveal no errors and/or problems with the digital display 104 and/or the link 109. Accordingly, the player 110 may set the second display status to indicate that the digital display 104 is not non-operational. After the process block 302, the flow 300 may transition to process block 304. After the process block 502, the flow 500 may transition to process block 504.

At the process block 504, the proof-of-play reporting engine 114 obtains the second display status. The proof-of-play reporting engine 114 may obtain the second display status from the player 110 via a transfer over the links 108.

To facilitate obtaining the second display status, the proof-of-play reporting engine 114 may provide to the player 110, via the links 108, a request for second display status so as to trigger the delivery of such information. In response to this request, the player 110 locates the second display status, and in turn, provides the second display status to the proof-of-play reporting engine 114 via the links 108.

Alternatively, the proof-of-play reporting engine 114 may obtain the second display status without providing a request to the player 110. The player 110 may, instead, push the second display status to the proof-of-play reporting engine 114. The pushing of the second display status may occur after the occurrence of an event, such as in response to any of a schedule; a play of the rendering content; and a change, revision, update, etc. to the source content; etc. As another alternative, the proof-of-play reporting engine 114 may obtain the second display status as a result of carrying out a synchronization routine with player 110.

After the process block 506, the flow 500 may transition to termination block 508. At termination block 508, the flow 500 terminates. Alternatively, the flow 500 may be repeated periodically, in continuous fashion, or upon being triggered as a result of a condition, such as an impetus to switch to different content (i.e., the fulfillment of the condition defines an event resulting in a trigger).

In addition, the process blocks 206-514 may be repeated periodically, in continuous fashion, or upon being triggered as a result of a condition, without repeating the entire flow 500. For example, the process blocks 206-514 may be repeated a number of times in response to impetuses to ascertain additional proofs-of play for the content. Other combinations and permutations are possible as well.

### First Alternative Example Architecture

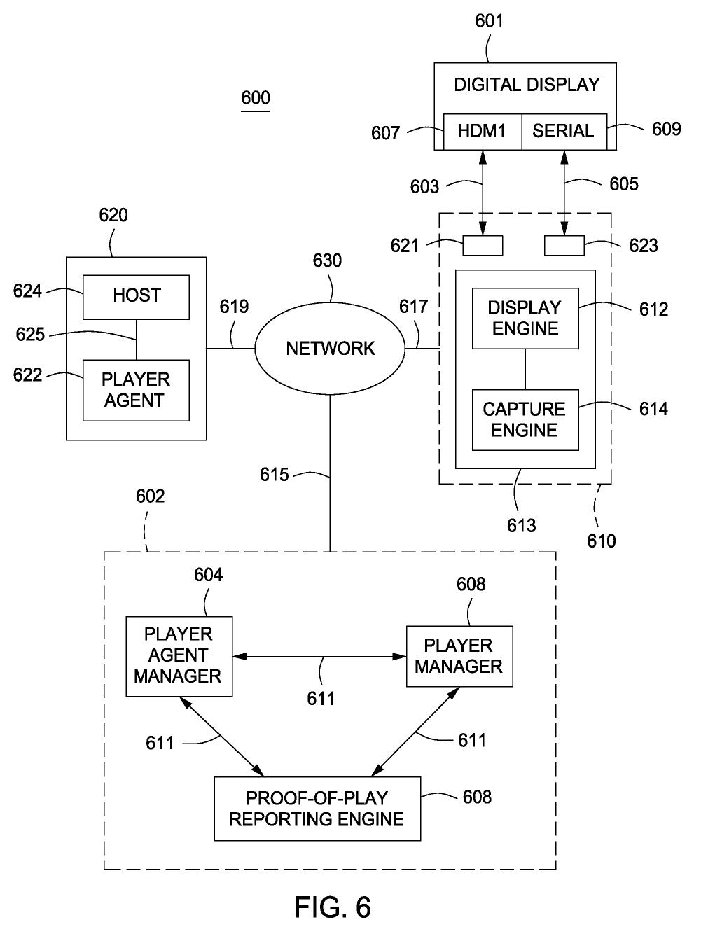

FIG. 6 is a block diagram illustrating example architecture of a system 600 for providing proof-of-play of digital signage. The system 600 includes three computing platforms, namely first, second and third computing platforms 602, 610 and 620, along with a digital display 601. The digital display 601 may communicatively couple to the second computing platform 610 via first and second communication links (or simply “links”) 603, 605. The computing platforms 602, 610 and 620 are typically general purpose computers that, when executing programs, operate as specific purpose computers that perform the functions discussed herein. The structure of these platforms is substantially similar to the computing platform 102 of FIG. 1, namely comprising at least one processor, support circuits and memory. These elements are not specifically shown in FIG. 6 for drawing clarity.

The first and second links 603, 605 may carry first and second sets of data, respectively, between the digital display 601 and the second computing platform 610. The first and second sets of data define respective formats. The first data-set format may be, for example, in accord with a high-definition-multimedia interface (“HDMI”) specification or protocol, such as HDMI specification version nos. 1.0, 1.2 or 1.3a. The second data-set format may be in accord with a serial communication protocol, such as or Recommended Standard 232 (“RS-232”).

The digital display 601 includes architecture similar to, and in turn, functions similarly to, the digital display 104 of FIG. 1. In addition, the digital display 601 may include an HDMI (“display HDMI”) 607 and a serial (“display-serial”) interface 609 along with one or more interfaces (not shown) for accepting input of video, audio and/or tactile information. Each of these (collectively “display-input”) interfaces may support a given standard and/or protocol. Examples of such standard or protocol include digital-visual interface (“DVI”), composite video, video graphics array (“VGA”)_component video (e.g., YPbPr component video), YCbCr video, analog audio, digital audio and like-type standards and/or protocols. Although not shown, the display-input interfaces may communicatively couple to the second computer platform 602 via respective links (not shown).

The display HDMI 607 and display-serial interface 609 communicatively couple to the second computing platform 610 via the first and second links 603, 605, respectively. The display HDMI 607 may support one or more of the HDMI specification version nos. 1.0, 1.2 or 1.3a, and in turn, a first set of commands of the HDMI specification (“HDMI-command set”). The display-serial interface 609 may support a given communication protocol along with a set of commands of the serial communication protocols (“serial-command set”).

For convenience and/or avoidance of repetition, the following may refer to the HDMI-command set and the serial-command set, collectively, as “display-interface-command set”. In addition, the following may refer to each of the commands of the HDMI-command set and serial-command set as “a display-interface command.”

Through support of the display-interface-command set, the display HDMI 607 and the display-serial interface 609 may provide health information for ascertaining one or more states, conditions and/or health of the display device 601 and/or the first and second links 603, 605. Examples of the display-interface-command set include ping, display-input and display-brightness commands. The ping, display-input and display-brightness commands define respective requests and responses. And as described in more detail below, the display HDMI 607 and the display-serial interface 609 may provide, in response to receiving any of the ping, display-input and display-brightness requests, provide corresponding ping, display-input and display-brightness responses.

For example, the display HDMI 607 and the display-serial interface 609 may, in response to receiving respective ping requests, issue respective (i.e., “HDMI-ping” and “serial-ping”) responses to indicate that the digital display 601 is reachable. These ping requests are abstractions of commands and not protocol specific functions i.e., the ping functionality is abstracted from TCP/IP techniques and applied to Serial or HDMI Communications. The display HDMI 607 and the display-serial interface 609 may, in response to receiving respective display-input requests, also issue respective (i.e., “HDMI-input” and “serial-input”) responses. The HDMI-input and serial-input responses may include respective indications that indicate which, if any, of the display-input interfaces is/are in use.

Additionally and/or alternatively, the display HDMI 607 and the display-serial interface 609 may, in response to receiving respective display-brightness requests, issue respective (i.e., “HDMI-brightness” and “serial-brightness”) responses. The HDMI-brightness and serial-brightness responses may include respective indications that indicate a measure of brightness of digital display 601. These measures (“display-brightness measures”) may define respective amounts of brightness in use by the digital display 601 at an instance in time or over a given time period. The amounts of brightness may be measured in units of candela per square meters (cd/m2), for instance. Each of the respective display-brightness measures may be, for example, a single measurement that is expected to be in a range of about 0-1000 cd/m2 for the instance of time. Alternatively, each of the respective display-brightness measures may be an amalgamation (e.g., an mean, median, etc.) of multiple measurements that are taken over the given time period (e.g., 5 seconds) and that are expected to be in the same range of about 0-1000 cd/m2.

After issuance of the HDMI-ping response, HDMI-input response, HDMI-brightness response, and/or other response to a command of the HDMI-command set, the device HDMI 607 may transmit such responses to the first link 603 for delivery to the second computer platform 602. Likewise, after issuance of the serial-ping response, serial-input response, serial-brightness response and/or other response to a display-interface command, the display-serial interface 609 may transmit such responses to the second link 605 for delivery to the second computer platform 602.

To facilitate communication to, from and/or among first, second and third computing platforms 602, 610 and 620, each of the first, second and third computing platforms 602, 610 and 620 may communicatively couple to a network 630 via respective communication links 615, 617 and 619. The network 630 may be, for example, a public network, a non-publicly accessible (“private”) network and/or some combination thereof.

As the public network or part thereof, the network 630 may be a partial or full deployment of most any telecommunication network, computer network or convergence thereof to which any interested member of the public can be provided with (e.g., served) communication services, including, for example, services for exchanging datagrams or packets. As such, the network 630 may be or include any part of a public, terrestrial wireless, and/or wireline telecommunications and/or computer network. The network 630 may, for example, include all or portions of the Internet, proprietary public networks, other public wired and/or wireless packet networks, etc.

As the private network or part thereof, the network 630 may be a partial or full deployment of most any telecommunication network, computer network or convergence thereof for serving the communication services to certain select groups, and not to the general public. Examples of the private network include an enterprise, military or service-provider managed wide-area network (“WAN”). The network 630 may also be or include any part of a Virtual Private Network (“VPN”) or any other partitioning of the public and/or private network.

Although the network 630 is shown as being contiguous, it may be a plurality of mutually exclusive networks, including, for example, autonomous systems and/or networks. In general, the network 630 provides, for entities that can connect to it, the ability to exchange communications with any first, second and third computing platforms 602, 610 and 620 and other network nodes (not shown) communicatively coupled thereto.

Each of the computing platforms 602, 610 and 620 may be formed as or in a single unitary device and concentrated on such device. Alternatively, each of the computing platforms 602, 610 and 620 may be formed in or from one or more separate devices, and as such, may be distributed among a number of devices. Each of the computing platforms 602, 610 and 620 may be scalable; i.e., each may employ any of a scale-up and scale-out approach. And each of the computing platforms 602, 610 and 620 may be integrated into or otherwise combined with another apparatus.

The first, second and third computing platforms 602, 610 and 620 include respective processors, memories, I/O interfaces and support circuits. The respective processors, memories, I/O interfaces and support circuits may communicatively couple via one or more respective communication links or busses.

The memories may store various software packages, including the operating systems and functional modules. The respective operating systems may include directives for operating the first, second and third computing platforms 602, 610 and 620. When retrieved from the memories and executed by the processors, the first, second and third computing platforms 602, 610 and 620 become platforms onto which the functional modules can be executed.

Each of functional modules includes one or more directives for causing the respective processors and/or the first, second and third computing platforms 602, 610 and 620 to carry out functions defined by such functional modules to facilitate, at least in part, providing a proof-of-play of the digital signage. Any of the functional modules may be in any of a standalone, client/server, peer-to-peer and other format. Alternatively and/or additionally, any of the functional modules may be formed as any of an autonomous agent, intelligent agent, autonomous intelligent agent, rational agent, intelligent software agent, distributed agent, mobile agent, fuzzy agent and the like.

Although the functional modules are described herein as software packages, the functional modules and/or the directives thereof may be formed in hardware and/or firmware. For example, the functional modules and/or the directives thereof may be ported or otherwise arranged for and implemented in any of a FPGA, ASIC, SoC and CPLD.

As shown, the third computing platform 620 includes a player agent 622 and a source-content host 624. The player agent 622 and source-content host 624 may be communicatively coupled via a link 625.

The source-content host 624 may, like the content source 106 of FIG. 1, host the source content and provide source-content copies for use as digital signage. The source-content host 624 may be an originator of the source content or may obtain (e.g., by fetching) the source content from other source content providers. The source-content host 624 may be or embody, for example, one or more web servers configured to host and to source the source-content copies. In such case, the source content may be maintained at source-content host 624 or other source content providers in one or more web pages; each of which may be formed in accordance with HTML or other like-type protocol, and/or accessible via one or more logical-link indicators.

The player agent 622 is similar to the player agent 112 of FIG. 1, and may carry out the functions of the player agent 112 described above with respect to FIGS. 2-6. In addition, the player agent 622 may carry out functions described below with respect to FIGS. 8-12.

The first computing platform 602 includes a player-agent manager 604, a player manager 606, and a proof-of-play reporting engine 608; each of which may communicatively couple via links 611. The proof-of-play reporting engine 608 is similar to the proof-of-play reporting engine 114 of FIG. 1, and may perform the functions of the proof-of-play reporting engine 114 described above with respect to FIGS. 2-6.

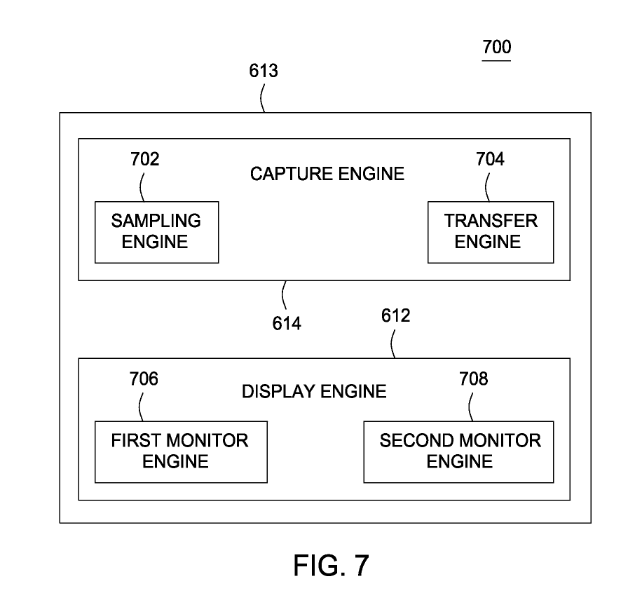

The second computing platform 610 includes a player 613. The player 613 is similar to the player 110 of FIG. 1, and may carry out the functions of the player 110 described above with respect to FIGS. 2-6. In addition, the player 613 includes a display engine 612 and a capture engine 614. Like the other functional modules, at least a portion of the functions of the player 613, the display engine 612 and capture engine 614 are described with respect to FIGS. 8-10. Details of example architecture of a player, which may be representative of the player 613, are described below with reference to FIG. 7.

In addition, the second computing platform 610 may include an HDMI 621 and a serial interface 623 along with one or more other interfaces (not shown) for outputting video, audio and/or tactile information; each of which operates under control of the player 613. Each of the other interfaces (“player-output interfaces”) may support a given standard and/or protocol. Examples of such standard or protocol for the player-output interfaces include DVI, composite video, video graphics array (“VGA”) component video, YCbCr video, analog audio, digital audio and like-type standards and/or protocols. Although not shown, the player-output interfaces may communicatively couple to the respective interfaces of the digital display 601 via respective links (not shown).

The HDMI (“player HDMI”) 621 and serial interface (“player-serial interface”) 623 communicatively couple to the display HDMI 607 and the display-serial interface 609 via the first and second links 603, 605, respectively. The player HDMI 621 may support one or more of the HDMI specification version nos. 1.0, 1.2 or 1.3a, and in turn, the HDMI-command set. And the player-serial interface 621 may support the serial communication protocol, and the serial-command set.

The player HDMI 621 and the player-serial interface 623, via support of the display-interface-command set, may collect, ascertain or otherwise garner the health information (e.g., the states, conditions and/or health) of the digital display 601 and/or the first and second links 603, 605. As described in more detail below, the player HDMI 621 and the player-serial interface 623 may, in accordance with the ping, display-input and display-brightness commands, issue respective ping, display-input and display-brightness requests.

The player HDMI 621 and the player-serial interface 623 may, for example, issue respective (i.e., “HDMI-ping” and “serial-ping”) requests to determine whether the digital display 601 is reachable. Alternatively, the player HDMI 621 and the player-serial interface 623 may issue respective (i.e., “HDMI-input” and “serial-input”) requests to cause the digital display 601 to indicate which, if any, of the display-input interfaces is/are in use. Additionally and/or alternatively, the player HDMI 621 and the player-serial interface 623 may issue respective (i.e., “HDMI-brightness” and “serial-brightness”) requests cause the digital display 601 to indicate the respective display-brightness measures.

After issuance of the HDMI-ping request, HDMI-input request, HDMI-brightness request, and/or other request of a command of the HDMI-command set, the player HDMI 621 may transmit such requests to the first link 603 for delivery to the digital display 601. Likewise, after issuance of the serial-ping request, serial-input request, serial-brightness request and/or other request of a display-interface command, the player-serial interface 623 may transmit such request to the second link 605 for delivery to the digital display 601.

Referring now to FIG. 7, a block diagram illustrating example architecture 700 of a player, which may be representative of the players 110, 613 of FIGS. 1 and 6, is shown. For convenience, however, the following describes the architecture of the player 700 with reference to the player 613 of FIG. 6.

The player 613 includes the display engine 612 and the capture engine 614. In general, the capture engine 614 facilitates obtaining confirming information formed from rendering content played by the player 613, and transferring the confirming information to the proof-of-play reporting engine 608. To facilitate its functions, the capture engine 614 may include a sampling engine 702 and a transfer engine 704.

The sampling engine 702 defines a capture algorithm for efficiently capturing the rendering content as played by the player 613. Advantageously, this capture algorithm allows capture of the rendering content without a degradation of performance of the player 613. To accomplish this, the sampling engine 702 may (i) obtain a time stamp, (ii) capture the rendering content from an output of the player 613, and (iii) associate the time stamp with the rendering content so captured.

To capture the rendering content, the sampling engine 702 may read the rendering content directly from the memory of the second computing platform 610 that is associated with the output of the player 613. Alternatively, the sampling engine 702 may capture raw data from the video memory of the display device 601 (e.g., the DMP) or capture raw data directly from the LCD. The sampling engine 702 may optionally compress the rendering content using a lossless compression algorithm. The sampling engine 702 may then combine the rendering content and time stamp so as to form a raw data version of the confirming information (“raw-confirming information”).

After forming the raw-confirming information, the sampling engine 702 may transfer the raw-confirming information to the transfer engine 704. The transfer engine 704, in turn, may provide the raw-confirming information to the player manager 606 via the network 630.

The display engine 614, in general, facilitates obtaining health information, generating the display status and/or transferring the display status and/or health information to the proof-of-play reporting engine 608. To facilitate its functions, the display engine 614 may include a first monitor engine 706 and a second monitor engine 708.

Pursuant to performing evaluations or diagnostics of the digital display 601 and/or the first and second links 603, 605, the first and second monitor engines 706, 708 monitor and collect, ascertain and/or garner the health information from the player HDMI 621 and player-serial interface 623, respectively. In addition, the first and second monitor engines 706, 708 may pass the health information to the display engine 614 for subsequent processing and/or for transfer from the player 613. Like the other functional modules, at least a portion of the functions of the first monitor engine 706, second monitor engine 708, the transfer engine 704 and sampling engine 702 are described with respect to at least one of the FIGS. 8-12.

### First Alternative Example Operation

FIG. 8 is a flow diagram illustrating example flow 800 for providing proof-of-play of digital signage. For convenience, the following describes the flow 800 with reference to the system architecture 600 of FIG. 6 and the architecture 700 of the player of FIG. 7 (“player architecture”). The flow 800 may be carried out by other architectures as well.

The flow 800 starts at termination block 802. Prior to the termination block 802, the first, second and third computing platforms 602, 610 and 620 become operative, such that their various software packages are retrieved from their memories and executed by their processors, thereby, making each of the first, second and third computing platforms 602, 610 and 620 function as one or more specially programmed computers to carry out any of the functions noted above and below. Unless otherwise indicated, any reference below to the various software packages, including the functional modules, assumes that such software packages (and directives therein) are under execution, and thus, cause the processors, in conjunction with other portions of the first, second and third computing platforms 602, 610 and 620 to carry out their functions noted above and below.

Sometime after termination block 802, the flow 800 may transition to process block 804. At the process block 804, the player 613 registers at the player manager 606. To facilitate this, the player 613 provides registration and/or authentication information (collectively “player credentials”) to the player manager 606. These player credentials may include, for example, any of a logical location indicator (e.g., an internet protocol (“IP”) address), username, password, etc. associated with the player 613. Using this information, the player manager 606 registers the player 613. After the process block 804, the flow 800 may transition to process block 806.

At the process block 806, the player-agent manager 604 obtains the player credentials. Typically, the player-agent manager 604 obtains the player credentials responsive to the player manager 606 sending them via the links 611. Alternatively, the player-agent manager 604 and the player manager 606 may exchange the player credentials via a sequence of requests and responses and/or a synchronization routine between the player-agent and player managers 604, 606. After the process block 806, the flow 800 may transition to process block 808.

At the process block 808, the player-agent manager 604, responsive to receiving the player credentials, installs (or causes installation of) an instance of a player agent, namely, the player agent 622, at the third computing platform 620. This may be carried out by the player-agent manager 604 sending to the third computing platform 620, via the network 630, a request for the third computing platform 620 to instantiate the player agent 622.

Alternatively, the player-agent manager 604 may send or download the player agent 622 as an object (e.g., a file) to the third computing platform 620, via the network 630. In this form, the player agent 622 may be runtime executable. Alternatively, the player agent 622 may, before being executable, undergo any of runtime or pre-runtime compiling. Additionally and/or alternative, the player agent 622 may be in the form of an abstraction of its directives. As such, the third computing platform 620, via libraries installed thereon, generates the player agent 622 from the abstraction.

In any case, the third computing platform 620 executes the player agent 622 to instantiate it. Once instantiated, the player agent 622 and the player 613 establish a one-to-one relationship, as described in more detail below. Pursuant to establishing the one-to-one relationship, the proofing and confirming information (formed by the player agent 622 and the player 613, respectively) that corresponds to each set of source-content copies may be tracked, matched and/or aligned.

After the process block 808, the flow 800 may transition to process block 810, whereupon the player agent 622 obtains the player credentials. The player agent 622 may use the player credentials to establish the one-to-one relationship with the player 613.

To facilitate obtaining the player credentials, the player-agent manager 604 may send the player credentials to the player agent 622 upon receiving the same after the player 613 registers with the player manager 606. Alternatively, the request to instantiate the player agent 622 (process block 808) may include the player credentials. Thus, after receiving the request to instantiate, the player agent 622 may extract the player credentials from such request, and as part of instantiating the player agent 622, the player agent 622 may use the player credentials to establish the relationship with the player 613. After the process block 810, the flow 800 may transition to process block 812.

At the process block 812, the player agent 622 exchanges content-tracking information with the capture engine 614. The content-tracking information defines a protocol by which the player agent 622 and the player 613 obtain the proofing and confirming information, respectively, for each set of source-content copies. Adhering to the protocol allows tracking, matching and/or aligning of the proofing and confirmation information. The content-tracking information may include, for example, any of clock information, a sampling frequency, a logical-link indicator and a sampling request.

The clock information may include a current date and/or current time. The capture frequency may be set to once per rendering of the digital signage. Alternatively, the capture frequency may be set to N times per rendering of the digital signage at an interval of M seconds, where N and M are integers. The capture frequency may also be normalized to a given number of times of content changes per second. The content-tracking information may include other information as well.

To facilitate the exchange of the content-tracking information, the player agent 622 may establish, via the network 630, a persistent communication channel with the capture engine 614. This persistent communication channel may be, for example, an always-on TCP session. After the process block 812, the flow 800 may transition to process block 814.

At the process block 814, the player 613 and player agent 622 obtain the first source-content copies for rendering on the digital display 601 as signage. Each of the player 613 and the player agent 622 may obtain the first source-content copies in response to providing respective source-content requests to the source-content host 624 via the network 630. As noted above, each of the respective source-content requests may include the logical-link indicator for triggering the delivery of the first source-content copies.

In response to logical-link indicator, the source-content host 624 locates the first source-content set. Thereafter, the source-content host 624 provides the first source-content copies to the player 613 and the player agent 622 via the respective I/O interfaces of the first and second computer platforms 610, 620.

Alternatively, each of the player 613 and the player agent 622 may obtain the first source-content copies without providing the respective source-content requests; e.g., responsive to the source-content host 624 pushing the first source-content copies thereto. As another alternative, each of the player 613 and the player agent 622 may obtain the first source-content copies as a result of carrying out the respective synchronization routines with the source-content host 624.

As part of obtaining the first source-content copies, the player agent 622 may also maintain in the memory of the third computing platform 620 a record of the first-source content (“first-source-content record”). This first-source-content record may include (i) virtual-rendering content formed by the player agent 622, and (ii) one or more time stamps inserted or interleaved with the virtual-rendering content.

To form such first virtual-rendering content, the player agent 622 plays the first source-content copies to a first content buffer (not shown) in the memory of the third computing platform 620. The player agent 622 may retrieve the first source-content copies to the first content buffer (i) periodically, e.g., in accordance with a given frequency, such as the capture frequency; (ii) continuously, e.g., at a frequency consonant with a protocol for recording the first source-content copies; and/or (iii) upon being triggered as a result of a condition, such as upon obtaining an indication to change to the second source-content copies.

The first content buffer may maintain the first virtual-rendering content for a given time period. After such time period, the content buffer may transfer the first virtual-rendering content to another portion of the memory of the third computing platform 602. Alternatively, the content buffer may flush or otherwise discard some or all of the first virtual-rendering content at the end of the time period. Accordingly, the player agent 622 or the third computing platform 602 may adjust the size of the content buffer based on an amount of bytes needed for the given period of time. Typically, no more than a few minutes worth of the first virtual-rendering content needs to be maintained in the content buffer.

The player agent 622 may also compress the first virtual-rendering content in accordance with a given compression protocol. For example, the player agent 622 may compress visual and/or auditory components of the first virtual-rendering content using video and/or audio compression techniques such as Motion Pictures Experts Group (“MPEG”) standards MPEG-2, MPEG-4, or the Joint Photographic Experts Group (JPEG).

Alternatively, the player agent 622 may form the first virtual-rendering content by recording, in accordance with a MPEG standard, a number of I-frames of the visual components of the first source-content copies. Since the I-frames define base information for the visual components of the first source-content copies, the I-frames would be sufficient to represent the visual components of the first source-content copies. Alternatively and/or additionally, the player agent 622 may compress the first virtual-rendering content so as to allow later decompression at a level of quality consistent with the first rendering content (process block 816, below).

As part of or adjunct to forming the first virtual-rendering content, the player agent 622 inserts into or interleaves the first virtual-rendering content with the time stamps. These time stamps are formed as a function of the clock information exchanged with the player 613 (process block 812). And each of the time stamps is offset from one another by a fraction of a second. The fraction may have a value that allows the player agent 622 to interleave one time stamp per frame of visual and/or auditory components of the virtual-rendering content. The value may be, for example, any of 1/30 of a second to coincide with a National Television System Committee (“NTSC”) standard, and 1/25 of a second to coincide with a Phase Alternating Line (“PAL”) standard. The value may also coincide with a frequency that corresponds to the player agent 622 recording each of the I-frames of the visual components of the first source-content copies.

After the process block 814, the flow 800 may transition to process block 816, whereupon, the player 613 plays the first rendering content to the digital display 601 for display as digital signage. To facilitate this, the player 613 may process the first source-content copies into the first rendering content, and as noted above, output the first rendering content to the digital display 601. After the process block 816, the flow 800 may transition to decision block 818.

At the decision block 818, the player 613 and/or the player agent 622 makes a determination as to whether it has obtained an indication to switch to a second set of source content (“second-source-content set”). If neither the player 613 nor the player agent 622 makes the determination in the affirmative (an “affirmative determination”), the flow 800 may transition to process block 814 (shown) and/or wait for a given amount of time and return to decision block 818 (not shown). If, on the other hand, either the player 613 or the player agent 622 makes the affirmative determination, then flow 800 may transition to process block 820.

The player 613 and/or the player agent 622 may obtain the indication to switch to the second source-content set in any number of ways. For example, the player 613 and/or the player agent 622 may receive, according to a schedule, a scheduling notification to switch to the second source-content set.

Alternatively, the player 613 and/or the player agent 622 may detect that the first source-content copies and/or the first logical-link indicator have changed. The player 613 and/or the player agent 622 may detect that the first source-content copies and/or the first logical-link indicator have changed as a result any change in and/or to the first source-content copies and/or the first logical-link indicator. This may include, for example, changes that result from obtaining the second source-content copies and/or obtaining the second logical-link indicator.

In one instance, the capture engine 614 of the player 613 may monitor the first source-content copies and/or the first logical-link indicator for changes by repeatedly forming, in accordance with the capture or other frequency, checksums of the first source-content copies and/or the first logical-link indicator, and then monitoring for changes in such checksums. Upon detecting a change in any of the checksums, the capture engine 614 determines that the first source-content copies and/or the first logical-link indicator have changed. After detecting the change, the capture engine 614 informs the player agent 622 by sending a message to it via the network 630. As an alternative to forming and monitoring checksums, the capture engine 614 may obtain and monitor snapshots and/or bit-maps of the first source-content copies.

The player agent 622 form the first set of information (“proofing information”) by processing the source-content copies into a form that is indicative of the source-content copies. This form may be, for example, any of a snapshot, checksum and bitmapped image of the source-content copies. The first information is transmitted through the network 130 to the player agent manager 604.

In another instance, the player agent 622 may monitor the first source-content copies and/or the first logical-link indicator for changes by repeatedly forming, in accordance with the capture or other frequency, checksums of the first source-content copies and/or the first logical-link indicator, and then monitoring for changes in these checksums. Responsive to detecting the change in any of the checksums, the player agent 622 determines that the first source-content copies and/or the first logical-link indicator have changed. After detecting the change, the player agent 622 informs the capture engine 614 by sending a message to it via the network 630. Alternatively, the player agent 622 may first begin storing the second-source content to another record in the memory of the third computing platform 620 (“second-source-content record”), and then notify the capture engine 614 of the content change. And as an alternative to forming and monitoring checksums, the player agent 622 may obtain and monitor snapshots and/or bit-maps of the first source-content copies.

As noted above, the flow 800 may transition to process block 820 upon making the affirmative determination. At the process block 820, the player agent 622 sends a capture request to the player 613 to cause the sampling engine 702 to (i) calculate a first time stamp; (ii) capture the first rendering content; (iii) form, as a function of the first time stamp and the first rendering content, the first raw-confirming information; and (iv) transfer the first raw-confirming information to the transfer engine 704. After the process block 820, the flow 800 may transition to process block 822.

At the process block 822, the player agent 622 forms the first proofing information. To facilitate this, the player agent 622 computes a second time stamp, and retrieves from the first-source-content record the virtual-rendering content associated a time stamp that matches or that is within a given timeframe from the second time stamp. Sometime thereafter, the player agent 622 processes such first virtual-rendering content into the first proofing information or, alternatively, sets or otherwise establishes such first virtual-rendering information as the first proofing information. After the process block 822, the flow 800 may transition to process block 824.

At the process block 824, the player manager 606 forms the first confirming information. To do this, the player manager 606 first obtains the first raw-confirming information from the transfer engine 704 via the network 630. To obtain the raw-confirming information, the player manager 606 may provide to the transfer engine 704, via the network 630, a request for the first raw-confirming information so as to trigger the delivery of such information. In response to this request, the transfer engine 704 locates the first raw-confirming information, and in turn, provides the first raw-confirming information to the player manager 606 via the network 630.

Alternatively, the player manager 606 may obtain the first raw-confirming information without providing a request to the transfer engine 704. Instead, the transfer engine 704 may push the first raw-confirming information to the player manager 606. As another alternative, the player manager 606 may obtain the first raw-confirming information as a result of carrying out a synchronization routine with transfer engine 704.

After obtaining the first raw-confirming information, the player manager 606 processes it into the first confirming information. The flow 800 may transition to process block 826 after the process block 824.

At the process block 826, the player 613 obtains the display status. To facilitate this, the display engine 612 may first perform an examination or diagnostic of any of the display device 601 and/or the first and second links 603, 605. During (or as a result of performing) the examination or diagnostic, the first and second monitor engines 706, 708 may collect, ascertain or otherwise garner the health information. Using the health information, the display engine 612 may ascertain the display status.

To perform the examination or diagnostic and/or to obtain the health information, the display engine 612 in combination with the digital display 601 and the first and second links 603, 605 may carry out one or more of the display-interface commands of the display-interface-command set. By way of example, the display engine 612 may issue the HDMI-ping request to the player HDMI 621 for delivery to the display HDMI 607. Upon receipt or at some later time, the player HDMI 621 transmits the HDMI-ping request to the first link 603.

Upon transmission or issuance of the HDMI-ping request or at some later time, the first monitoring engine 706 begins monitoring the player HDMI 621 for the HDMI-ping response. Assuming that the player HDMI-ping request successfully reaches the display HDMI 607 and the display HDMI 607 is operating properly, the display HDMI 607 issues the HDMI-ping response for delivery to the player HDMI 621 via the first link 603. And assuming that the HDMI-ping response successfully reaches the player HDMI 621 (in a timely manner or at all), the first monitoring engine 706 acknowledges receipt of the HDMI-ping response and informs the display engine 612 of such receipt. Thereafter, the display engine 612 populates the health information with an indication that indicates a successful execution of the ping command (“successful-HDMI ping”).

If (i) the HDMI-ping request does not reach the display HDMI 607; (ii) the display HDMI 607 does not issue or transmit the HDMI-ping response, in a timely manner or at all; (iii) the HDMI-ping response does not reach the player HDMI 621, in a timely manner or at all; and/or (iv) the player HDMI 621 does not acknowledge receipt of the HDMI-ping response, then the first monitoring engine 706 informs the display engine 612 of a lack of receiving the HDMI-ping response. Responsively, the display engine 612 populates the health information with an indication that indicates an unsuccessful execution of the ping command (“unsuccessful-HDMI ping”).

As another example, the display engine 612 may issue the serial-ping request from the player serial interface 623 for delivery to the display-serial interface 609. Upon receipt or at some later time, the player-serial interface 623 transmits the serial-ping request to the second link 605.

Upon transmission or issuance of the player-serial-ping request or at some later time, the second monitoring engine 708 begins monitoring the player-serial interface 623 for the serial-ping response. Assuming that the serial-ping request successfully reaches the display-serial interface 609 and the serial-HDMI 609 is operating properly, the display-serial interface 609 issues the serial-ping response for delivery to the player-serial interface 623 via the second link 605. And assuming that the serial-ping response successfully reaches the player-serial interface 623 (in a timely manner or at all), the second monitoring engine 708 acknowledges receipt of the serial-ping response and informs the display engine 612 of such receipt. Thereafter, the display engine 612 populates the health information with an indication that indicates a successful execution of the ping command (“successful-serial ping”).

If, on the other hand, (i) the serial-ping request does not reach the display-serial interface 609; (ii) the display-serial interface 609 does not issue or transmit the serial-ping response, in a timely manner or at all; (iii) the serial-ping response does not reach the player-serial interface 623, in a timely manner or at all; and/or (iv) the player-serial interface 623 does not acknowledge receipt of the serial-ping response, then the second monitoring engine 708 informs the display engine 612 of a lack of receiving the serial-ping response. Responsively, the display engine 612 populates the health information with an indication that indicates an unsuccessful execution of the ping command (“unsuccessful-serial ping”).

As a further example, the display engine 612 may issue the HDMI-input request to the player HDMI 621 for delivery to the display HDMI 607. Upon receipt or at some later time, the player HDMI 621 transmits the HDMI-input request to the first link 603.

Upon transmission or issuance of the HDMI-input request or at some later time, the first monitoring engine 706 begins monitoring the player HDMI 621 for the HDMI-input response. Assuming that the HDMI-input request successfully reaches the display HDMI 607 and the display HDMI 607 is operating properly, the display HDMI 607 issues the HDMI-input response for delivery to the player HDMI 621 via the first link 603. This HDMI-input response includes the indications that indicate which, if any, of the digital-display-input interfaces is/are in use (“interfaces-in-use indications”).

Assuming that the HDMI-input response successfully reaches the player HDMI 621 (in a timely manner or at all), the first monitoring engine 706 acknowledges receipt of the HDMI-input response, extracts the interfaces-in-use indications and provides them to the display engine 612. Thereafter, the display engine 612 populates the health information with at least a portion of the interfaces-in-use indications.

On the other hand, if (i) the HDMI-input request does not reach the display HDMI 607; (ii) the display HDMI 607 does not issue or transmit the HDMI-input response, in a timely manner or at all; (iii) the HDMI-input response and/or the interfaces-in-use indications do not reach the player HDMI 621, in a timely manner or at all; and/or (iv) the player HDMI 621 does not acknowledge receipt of the HDMI-input response and/or the interfaces-in-use indications, then the first monitoring engine 706 informs the display engine 612 of a lack of receiving the HDMI-input response. Responsively, the display engine 612 populates the health information with an indication that indicates an unsuccessful execution of the display-input command (“unsuccessful-input detection”).

Although the foregoing describes the display engine 612 populating the health information with the interfaces-in-use indications or the unsuccessful-input detection responsive to the display-input command being carried out via the player HDMI 621, the display HDMI 607 and the first link 603, the display engine 612 may populate the health information with the interfaces-in-use indications or the unsuccessful-input detection responsive to the display-input command being carried out via the player-serial interface 623, the display-serial interface 609 and the second link 605 using a like-type sequence. This like type sequence may include the serial-input request and response, instead of the HDMI-input request and response.

As yet another example, the display engine 612 may issue the HDMI-brightness request to the player HDMI 621 for delivery to the digital-display HDMI 607. Upon receipt or at some later time, the player HDMI 621 transmits the HDMI-brightness request to the first link 603. Upon transmission or issuance of the HDMI-brightness request or at some later time, the first monitoring engine 706 begins monitoring the player HDMI 621 for the HDMI-brightness response. Assuming that the HDMI-brightness request successfully reaches the display HDMI 607 and the display HDMI 607 is operating properly, the display HDMI 607 issues the HDMI-brightness response for delivery to the player HDMI 621 via the first link 603. This HDMI-brightness response includes the display-brightness measure.

Assuming that the HDMI-brightness response successfully reaches the player HDMI 621 (in a timely manner or at all), the first monitoring engine 706 acknowledges receipt of the HDMI-brightness response, extracts the display-brightness measure and provides the display-brightness measure to the display engine 612. Thereafter, the display engine 612 populates the health information with display-brightness measure.

On the other hand, if (i) the HDMI-brightness request does not reach the display HDMI 607; (ii) the display HDMI 607 does not issue or transmit the HDMI-brightness response, in a timely manner or at all; (iii) the HDMI-brightness response and/or the display-brightness measure do not reach the player HDMI 621, in a timely manner or at all; and/or (iv) the player HDMI 621 does not acknowledge receipt of the HDMI-brightness response and/or the display-brightness measure, then the first monitoring engine 706 informs the display engine 612 of a lack of receiving the HDMI-brightness response. Responsively, the display engine 612 populates the health information with an indication that indicates an unsuccessful execution of the display-brightness command (“unsuccessful-brightness detection”).

Although the foregoing describes the display engine 612 populating the health information with the display-brightness measure or the unsuccessful-brightness detection responsive to the HDMI-brightness command being carried out via the player HDMI 621, the display HDMI 607 and the first link 603, the display engine 612 may populate the health information with the display-brightness measure or the unsuccessful-brightness detection responsive to the display-input command being carried out via the player-serial interface 623, the digital-display-serial interface 609 and the second link 605 using a like-type sequence. This like type sequence may include the serial-brightness request and response, instead of the HDMI-brightness request and response.

The display engine 612 may carry out the display-interface commands in a logical order. For example, the display engine 612 may carry out the ping command before any of the other display-interface commands. This way, the display engine 612 may forego performing the other display-interface commands response to the unsuccessful-HDMI ping and/or the unsuccessful-serial ping. In addition, the display engine 612 may forego performing one or more of the display-interface commands via the display-serial interface 609 and the player-serial interface 623 when equivalent display-interface commands are carried out previously by display HDMI 607 and the player HDMI 621 (and vice versa).

The display engine 612 may transfer the health information to the player 613. This may include transferring any of the successful-HDMI ping, unsuccessful-HDMI ping, successful-serial ping, unsuccessful-serial ping, interfaces-in-use indications, unsuccessful-input detection, display-brightness measure and unsuccessful-brightness detection to the player 613. After receipt, the player 613 examines the health information. And upon determining that the health information includes one or more of the unsuccessful-HDMI ping, unsuccessful-serial ping, unsuccessful-input detection and unsuccessful-brightness detection, the player 613 sets the display status to indicate that the digital display 601 is non-operational.

If the health information does not include one or more of the unsuccessful-HDMI ping, unsuccessful-serial ping, unsuccessful-input detection and unsuccessful-brightness detection, then the player 613 may evaluate the display-brightness measure for compliance with an acceptable level or range of levels of brightness. To do this, the player 613 may determine whether the display-brightness measure satisfies a given threshold or set of thresholds. The given threshold may be, for example, a minimum level or maximum level of brightness. The given set of thresholds may be both the maximum level and minimum level of brightness. The minimum level of brightness may be set at or about 50 cd/m2, and the maximum level of brightness may be set at or about 300 cd/m2. If the player 613 determines that the display-brightness measure fails to comply with the acceptable level or range of levels of brightness, then the player 613 sets the display status to indicate that the digital display 601 is non-operational.

On the other hand, if the player 613 determines that the display-brightness measure complies with the acceptable level or range of levels of brightness, then the player 613 may determine whether the interfaces-in-use indications match or otherwise correspond to the output interfaces of the player 613 that are used for outputting the first rendering content (“in-use-output interfaces”). If the player 613 determines that the interfaces-in-use indications fail to match or otherwise correspond to the in-use-output interfaces, then the player 613 sets the display status to indicate that the digital display 601 is non-operational. If, on the other hand, the player 613 determines that the interfaces-in-use indications match or otherwise correspond to the in-use-output interfaces, then the player 613 may set the display status to indicate that the digital display 601 is not non-operational.

After the player 613 obtains the display status, the flow 800 may transition to process block 828. At the process block 828, the proof-of-play reporting engine 608 obtains the first proofing information, first confirming information and display status. The proof-of-play reporting engine 114 may obtain the first proofing information from the player agent 622 via the link 615, player agent manager 604 and link 611. To facilitate obtaining the first proofing information, the proof-of-play reporting engine 114 may provide to the player agent 622 the request for the first proofing information. In response to this request, the player agent 622 locates the first proofing information, and in turn, provides the first proofing information to the player agent manager 604. Thereafter, the player agent manager 604 may provide the first proofing information to the proof-of-play reporting engine 114 via links 611 (e.g., pursuant to simple network management protocol (“SNMP”) monitoring).

Alternatively, the proof-of-play reporting engine 114 may obtain the first proofing information without providing the request to the player agent 622. Instead, the player agent 622 may push the first proofing information to the player agent manager 604, responsive the occurrence of an event, such as in response to any of a schedule; a play of the rendering content; and a change, revision, update, etc. to the source content; etc. Thereafter, the player agent manager 604 may provide the first proofing information to the proof-of-play reporting engine 114 via links 611 (e.g., pursuant to SNMP monitoring).

As another alternative, the proof-of-play reporting engine 608 may obtain the first proofing information as a result of carrying out a synchronization routine with the player agent 622. After synchronization, the player agent manager 604 may provide the first proofing information to the proof-of-play reporting engine 114 via links 611.

The proof-of-play reporting engine 608 may obtain the first confirming information from the player manager 606 via the link 611. To do this, the proof-of-play reporting engine 608 may provide to the player manager 606 the request for the first confirming information. In response to this request, the player manager 606 locates the first confirming information, and in turn, provides (e.g., pursuant to SNMP monitoring) the first confirming information to the proof-of-play reporting engine 608. Alternatively, the proof-of-play reporting engine 608 may obtain the first confirming information without providing the request to the player manager 606. Instead, the player manager 606 may push the first confirming information to the proof-of-play reporting engine 608, responsive the occurrence of an event, such as in response to any of a schedule; a play of the rendering content; and a change, revision, update, etc. to the source content; etc. As another alternative, the proof-of-play reporting engine 608 may obtain the first confirming information as a result of carrying out a synchronization routine with the proof-of-play reporting engine 608.

The proof-of-play reporting engine 608 may obtain the display status from the player 613 via the link 615, player manager 606 and link 611. To facilitate obtaining the display status, the proof-of-play reporting engine 608 may provide to the player 613 the request for the display status. In response to this request, the player 613 locates the display, and in turn, provides the display status to the player manager 606. Thereafter, the player manager 606 may provide the display status to the proof-of-play reporting engine 608 via links 611 (e.g., pursuant to SNMP monitoring).

Alternatively, the proof-of-play reporting engine 608 may obtain the display status without providing the request to the player 613. Instead, the player 613 may push the display status to the player manager 606, responsive the occurrence of an event, such as in response to any of a schedule; a play of the rendering content; and a change, revision, update, etc. to the source content; etc. Thereafter, the player manager 606 may provide the display status to the proof-of-play reporting engine 608 via links 611 (e.g., pursuant to SNMP monitoring).

As another alternative, the player manager 606 may obtain the display status as a result of carrying out a synchronization routine with the player 613. After synchronization, the player manager 606 may provide the display status to the proof-of-play reporting engine 608 via links 611.

After the process block 828, the flow 800 may transition to process block 930. At the process block 930, the proof-of-play reporting engine 608 ascertains a proof-of-play of the source content when (i) the first proofing and first confirming information are in correspondence or otherwise correlate, and (ii) the display status reflects that the digital display 601 is operational. This may include, for example, the proof-of-play reporting engine 608 first ascertaining an intermediate proof-of-play as a function of a comparison (e.g., using an MSE algorithm) between the first proofing and first confirming information. The proof-of-play reporting engine 608 may do this by initially generating a result from the comparison, and then making a determination as to whether the result satisfies a given threshold. When the determination indicates that the result satisfies the given threshold, the first proofing and first confirming information are in correspondence or otherwise correlate.

After ascertaining the intermediate proof-of-play, the proof-of-play reporting engine 608 may examine the display status. If, upon examination, the display status indicates that the digital display 601 is non-operational, then the proof-of-play reporting engine 608 does not ascertain the proof-of-play. On the other hand, the proof-of-play reporting engine 608 ascertains the proof-of-play when the display status indicates that the digital display 601 is not non-operational.

While the foregoing describes the proof-of-play reporting engine 608 ascertaining the intermediate proof-of-play as a function of the first proofing and first confirming information, the proof-of-play reporting engine 608 may instead ascertain the intermediate proof-of-play as a function of the display status (i.e., when the display status reflects that the digital display 601 is not non-operational). Thereafter, the proof-of-play reporting engine 608 may ascertain the proof-of-play as a function of the first proofing and first confirming information.

After the process block 830, the flow 700 may transition to termination block 832, whereupon the flow 800 terminates. Alternatively, the flow 800 may be repeated periodically, in continuous fashion, or upon being triggered as a result of a condition, such as an impetus to switch to different content (i.e., the fulfillment of the condition defines an event resulting in a trigger).

In addition, the process blocks 814-830 may be repeated periodically, in continuous fashion, or upon being triggered as a result of a condition, without repeating the entire flow 800. For example, the process blocks 814-830 may be repeated a number of times in response to impetuses to determine additional proofs-of play for the content. Other combinations and permutations are possible as well.

### Second Alternative Example Architecture

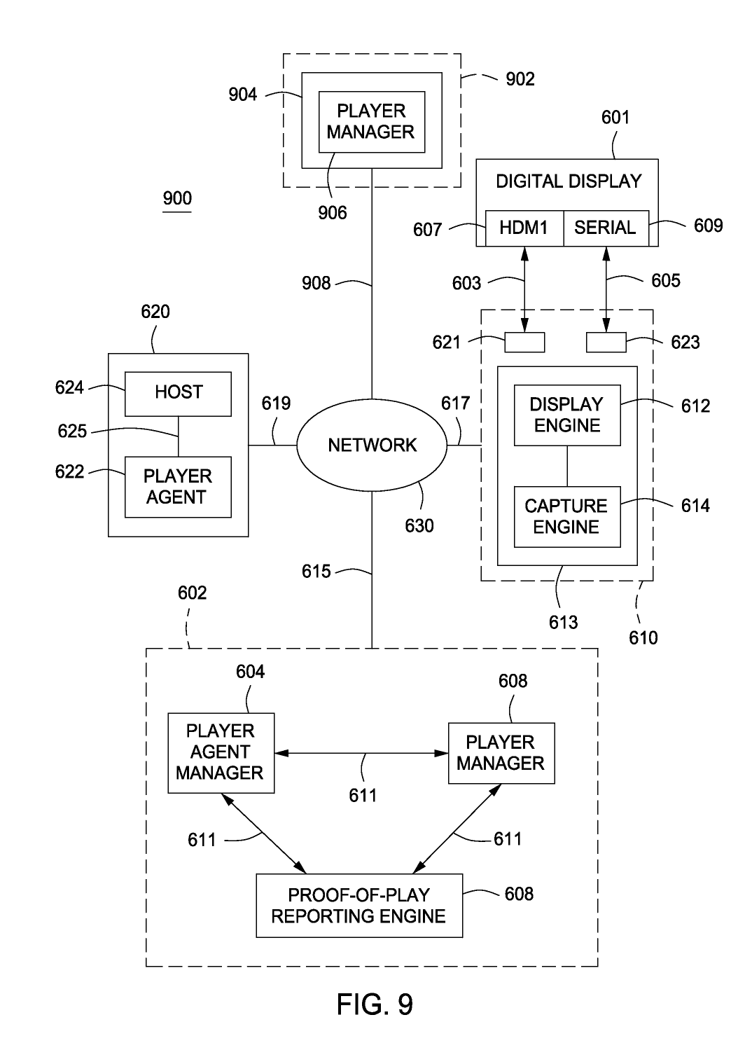

FIG. 9 is a block diagram illustrating example architecture of a system 900 for providing proof-of-play of digital signage. The system 900, like the system 600 of FIG. 6, includes the digital display 601 along with the first, second and third computing platforms 602, 610 and 620. The system 900 also includes a fourth computing platform 902.

To facilitate communication to, from and/or among first, second, third and fourth computing platforms 602, 610, 620 and 902, each of the first, second, third and fourth computing platforms 602, 610, 620 and 902 may communicatively couple to the network 630 via respective communication links 615, 617, 619 and 908.

Like each of the first, second and third computing platforms 602, 610 and 620, the fourth computing platform 902 includes a processor, memory, I/O interfaces and support circuits. The processor, memory, I/O interfaces and support circuits of the fourth computing platform 902 may communicatively couple via one or more respective communication links or busses. The memory may store various software packages, including the operating systems and functional modules. The operating system may include directives for operating the fourth computing platform 902. When retrieved from the memory and executed by the processor, the fourth computing platform 902 becomes a platform onto which a number of functional modules can be executed.

Each of functional modules of the fourth computing platform 902 includes one or more directives for causing the processor and/or the fourth computing platforms 902 to carry out functions defined by such functional modules to facilitate, at least in part, providing a proof-of-play of the digital signage. Any of the functional modules may be in any of a standalone, client/server, peer-to-peer and other format. Alternatively and/or additionally, any of the functional modules may be formed as any of an autonomous agent, intelligent agent, autonomous intelligent agent, rational agent, intelligent software agent, distributed agent, mobile agent, fuzzy agent and the like. Although the functional modules are described herein as software packages, the functional modules and/or the directives thereof may be formed in hardware and/or firmware. For example, the functional modules and/or the directives thereof may be ported or otherwise arranged for and implemented in any of a FPGA, ASIC, SoC and CPLD.

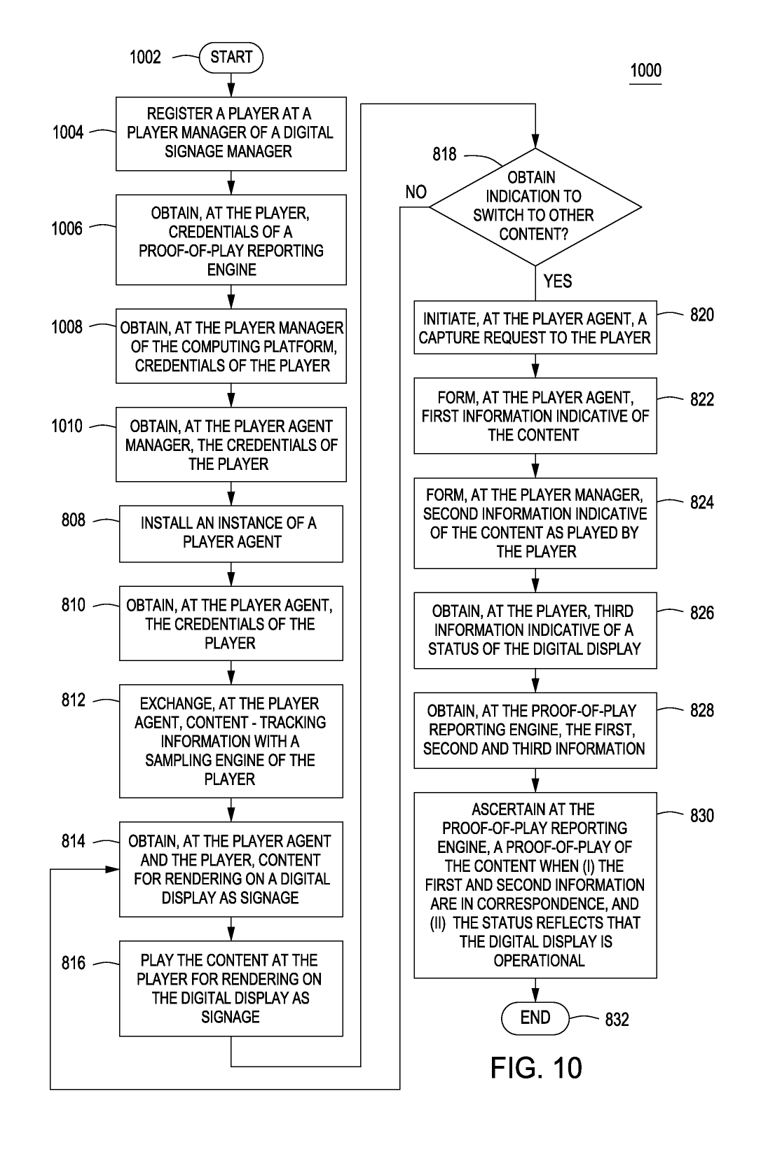

The functional modules of the fourth computing platform 902 may include a digital-signage manager 904. The digital-signage manager 904 beneficially provides for effective scaling of the system 900 by carrying out administration, management and/or handling of the player 613 and/or additional players (not shown). To facilitate this, the digital-signage manager 904 includes a player manager (“DSM-player manager”) 906. As described in more detail below with respect to FIG. 10, the DSM-player manager 906 usurps or otherwise assumes some of the functionality of the player manager 606 of the first computer platform 602.

### Second Alternative Example Operation

FIG. 10 is a flow diagram illustrating example flow 1000 for providing proof-of-play of digital signage. For convenience, the following describes the flow 1000 with reference to the architecture of systems 600, 900 of FIGS. 6 and 9, respectively, along with the flow 800 of FIG. 8. The flow 1000 may be carried out by other architectures as well. In addition, the flow 1000 is similar to the flow 800 of FIG. 8, except as described herein below.

The flow 1000 starts at termination block 1002. Prior to the termination block 1002, the first, second, third and fourth computing platforms 602, 610, 620 and 902 become operative, such that their various software packages are retrieved from their memories and executed by their processors, thereby, making each of the first, second and third computing platforms 602, 610 and 620 function as one or more specially programmed computers to carry out any of the functions noted above and below. Unless otherwise indicated, any reference below to the various software packages, including the functional modules, assumes that such software packages (and directives therein) are under execution, and thus, cause the processors, in conjunction with other portions of the first, second, third and fourth computing platforms 602, 610, 620 and 902 to carry out their functions noted above and below.

Sometime after termination block 1002, the flow 1000 may transition to process block 1004. At the process block 1004, the player 613 registers at the DSM-player manager 906. To facilitate this, the player 613 provides the player credentials to the DSM-player manager 906. Using this information, the DSM-player manager 906 registers the player 613. After the process block 1004, the flow 1000 may transition to process block 1006.

At the process block 1006, the player 613 obtains credentials of the proof-of-play reporting engine 608 (“pop-engine credentials”). The player 613 may obtain the pop-engine credentials responsive to the DSM-player manager 906 sending them via the network 630. Alternatively, the player 613 and DSM-player manager 906 may exchange the pop-engine credentials via a sequence of requests and responses and/or a synchronization routine between the player 613 and DSM-player manager 906. After the process block 1006, the flow 1000 may transition to process block 1008.

At the process block 1008, the player manager 606 obtains the player credentials. Typically, the player manager 606 obtains the player credentials responsive to the DSM-player manager 906 sending them via the network 630. Alternatively, the player manager 606 and the DSM-player manager 906 may exchange the player credentials via a sequence of requests and responses and/or a synchronization routine between the player manager 606 and DSM-player manager 906. After the process block 1008, the flow 1000 may transition to process block 1010.

At the process block 1010, the player-agent manager 604 obtains the player credentials. Typically, the player-agent manager 604 obtains the player credentials responsive to the DSM-player manager 906 sending them via the network 630. Alternatively, the player-agent manager 604 and the DSM-player manager 906 may exchange the player credentials via a sequence of requests and responses and/or a synchronization routine between the player-agent manager 604 and the DSM-player manager 906.

After the process block 1010, the flow 1000 may transition to process block 808, whereupon the process blocks 808-830 are carried out as described above with respect to the flow 800 of FIG. 8. After the process block 830, the flow 1000 may transition to termination block 1012.

At the termination block 1012, the flow 1000 may end. Alternatively, the flow 1000 may be repeated periodically, in continuous fashion, or upon being triggered as a result of a condition, such as an impetus to switch to different content and/or to add additional players to the system 900 (i.e., the fulfillment of the condition defines an event resulting in a trigger).

In addition, the process blocks 814-830 may be repeated periodically, in continuous fashion, or upon being triggered as a result of a condition, without repeating the entire flow 1000. For example, the process blocks 814-830 may be repeated a number of times in response to impetuses to ascertain additional proofs-of play for the content.

Further, the DSM-player manager 906, instead of the player manager 606, may carry out the functions associated with the process blocks 822-830. Other combinations and permutations are possible as well.

While the foregoing is directed to embodiments of the present invention, other and further embodiments of the invention may be devised without departing from the basic scope thereof, and the scope thereof is determined by the claims that follow.

What is claimed is:

1. A method comprising:
obtaining first information indicative of content for rendering on a display as digital signage;
obtaining second information indicative of the content as played by a player for rendering on the display; and
ascertaining a proof-of-play of the content when the first and second information are in correspondence.

2. The method of claim 1, wherein the first information comprises at least one of a snapshot, checksum or bit-mapped image of the content, and wherein the second information comprises at least one of a snapshot, checksum or bit-mapped image of the content as played.

3. The method of claim 1, further comprising:
obtaining the content from a source;
playing the content;
forming, at the player, the second information as played; and
transmitting the second information from the player to a proof-of-play reporting engine.

4. The method of claim 3, further comprising:
obtaining the content from the source;
forming the first information from the content; and
transmitting the first information from the source to the proof-of-play reporting engine.

5. The method of claim 4, further comprising:
playing the content from a source, wherein the source forms the player;
forming, at the source, the second information as played; and
transmitting the second information from the source to the proof-of-play reporting engine.

6. The method of claim 1 further comprising:
obtaining third information indicative of a status of the display;
ascertaining a proof-of-play of the content when (i) the first and second information are in correspondence, and (ii) the status reflects that the display is operational.

7. The method of claim 1 further comprising forming the second information upon the occurrence of an event.

8. The method of claim 7 wherein the event is a transition from the content to a second content.

9. The method of claim 1 further comprising forming the second information by capturing data from the display.

10. An apparatus comprising:
a proof-of-play reporting engine for:
obtaining first information indicative of content for rendering on a display as digital signage;
obtaining second information indicative of the content as played by a player for rendering on the display; and
ascertaining a proof-of-play of the content when the first and second information are in correspondence.

11. The apparatus of claim 10, wherein the player forms the second information as the player plays the content and transmits the second information to the proof-of-play reporting engine.

12. The apparatus of claim 10, further comprising a player agent for forming the first information from the content and transmitting the first information to the proof-of-play reporting engine.

13. The apparatus of claim 10, wherein the proof-of-play reporting engine obtains third information indicative of a status of the display and ascertains a proof-of-play of the content when (i) the first and second information are in correspondence, and (ii) the status reflects that the display is operational.

14. The apparatus of claim 10, wherein the first information comprises any of a snapshot, checksum and bit-mapped image of the content, and wherein the second information comprises any of a snapshot, checksum and bit-mapped image of the content as played.

15. The apparatus of claim 10 wherein the player forms the second information upon the occurrence of an event.

16. The apparatus of claim 15 wherein the event is a change from the first content to a second content.

17. An apparatus comprising:
means for generating a first information indicative of content for rendering on a display as digital signage;
means for generating second information indicative of the content as played by a player for rendering on the display; and
means for ascertaining a proof-of-play of the content when the first and second information are in correspondence.

18. The apparatus of claim 17, wherein the first information comprises at least one of a snapshot, checksum or bit-mapped image of the content, and wherein the second information comprises at least one of a snapshot, checksum or bit-mapped image of the content as played.

19. The apparatus of claim 17 further comprising:
means for generating third information indicative of a status of the display; and
means for ascertaining a proof-of-play of the content when (i) the first and second information are in correspondence, and (ii) the status reflects that the display is operational.

20. The apparatus of claim 17 further comprising means for forming the second information upon the occurrence of an event.
